(19) United States
(12) Patent Application Publication
(10) Pub. No.: US 2017/0091429 A1
(43) Pub. Date: Mar. 30, 2017

(54) LICENSE MANAGEMENT METHOD AND SEMICONDUCTOR DEVICE SUITED FOR LICENSE MANAGEMENT

(71) Applicant: Renesas Electronics Corporation, Tokyo (JP)

(72) Inventors: Koichi ISHIMI, Tokyo (JP); Masaya KITAO, Tokyo (JP)

(21) Appl. No.: 15/234,975

(22) Filed: Aug. 11, 2016

(30) Foreign Application Priority Data
Sep. 29, 2015 (JP) 2015-192013

(51) Int. Cl. G06F 21/10

(52) U.S. Cl. CPC G06F 21/105; G06Q 2220/18

(57) ABSTRACT

A license management method of performing license management using an execution unit that executes software and a software storage unit coupled to the execution unit includes the step of controlling execution of software that is stored in the software storage unit and on which a license is granted with a term being limited by the execution unit on the basis of term information that indicates the term by using a license management unit that controls execution of the software.

### CROSS-REFERENCE TO RELATED APPLICATIONS

The disclosure of Japanese Patent Application No. 2015-192013 filed on Sep. 29, 2015 including the specification, drawings and abstract is incorporated herein by reference in its entirety.

### BACKGROUND

The present invention relates to a license management method and a semiconductor device suited for license management, and particularly relates to the license management method of managing licenses of software and the semiconductor device suited for license management.

As the semiconductor device that executes the software, for example, a microprocessor is available. It becomes possible to couple the microprocessor to various things via a communication line such as, for example, the Internet and so forth with development of IoT (Internet of Things). The software is requested in order to make the microprocessor perform a desired operation. In this case, since the microprocessor is coupled to the various things via the communication line, it is conceived that a software distribution source provides the software to the microprocessor via the communication line.

Although there exist various kinds of software, the software is broadly divided into software that is requested to acquire licensing in order to use the software (hereinafter, also referred to as paid software) and software that is not requested to acquire licensing (hereinafter, also referred to as free software). In case of the paid software, use of the software is permitted by paying a license fee that is an equivalent of the license.

It is effective for a user who intends to purchase the paid software from the software distribution source to confirm (try) whether a desired operation is performed by the paid software before paying the license fee in order to save the expenses. Therefore, it is desirable that the paid software on which a license is granted for a predetermined period (a trial period) be provided from the software distribution source (hereinafter, also simply referred to as the distribution source). In this case, the license of the paid software is granted, for example, without charge with the predetermined period being defined as a term and it becomes important for the software distribution source to manage the term.

From the view point of term management, technologies related to term management for IC cards are described in, for example, Japanese Patent No. 2598047 and Japanese Unexamined Patent Application Publication No. 2005-10991.

### SUMMARY

Since when the software (the paid software) that licensing is requested is to be distributed, collection of the license fee is involved, the software is distributed with charge. In this case, it is requested to surely perform license management of the paid software. In addition, it is desired to reduce loads exerted on the user and/or the distribution source in license management.

In Japanese Patent No. 2598047 and Japanese Unexamined Patent Application Publication No. 2005-10991, no attention is paid to management of the term of the paid software (hereinafter, also referred to as term-limited paid software or term-limited software) on which the license is granted. It goes without saying that a technology of performing term management for every piece of term-limited software is not described.

Other subject matters and novel features of the present invention will become apparent from the following description of the present specification and the appended drawings.

In the present specification, a plurality of solutions for the above-mentioned drawbacks are disclosed. Here, typical solutions will be described.

According to one embodiment of the present invention, there is provided a license management method of managing licenses by using an execution unit that executes software, a software storage unit coupled to the execution unit, and a license management unit. Here, the license management method includes the step of controlling execution of term-limited software by the execution unit on the basis of term information that indicates the term by using the license management unit.

Since execution of the term-limited software is controlled on the basis of the term information, it becomes possible to reduce the loads on the user and/or the distribution source. In addition, it is also possible to extend a period that it is possible for the user to execute the paid software by changing the term information. Further, it is also possible to cancel the term of the term-limited software by changing the term information.

According to one embodiment of the present invention, it is possible to provide the license management method that makes it possible to reduce the loads on the user and/or the distribution source.

### BRIEF DESCRIPTION OF THE DRAWINGS

FIG. 1 is a configurational diagram illustrating one example of a license management model according to a first embodiment.

FIG. 2 is a block diagram illustrating one example of a configuration of a license management unit according to the first embodiment.

FIG. 3 is a block diagram illustrating one example of a configuration of part of a microprocessor according to the first embodiment.

FIG. 4 is a configurational diagram illustrating one example of the license management model according to the first embodiment.

FIG. 5 is an explanatory diagram illustrating one example of a table relevant to valid term information included in the license management unit according to the first embodiment.

FIG. 6 is a block diagram illustrating one example of one configuration of part of the license management unit according to the first embodiment.

FIG. 7 is a block diagram illustrating one example of another configuration of the part of the license management unit according to the first embodiment.

FIG. 8 is a block diagram illustrating one example of a configuration of the license management unit according to the first embodiment.

FIG. 9 is a flowchart illustrating one example of one function according to a second embodiment.

FIG. 10 is a flowchart illustrating one example of another function according to the second embodiment.

FIG. 11 is a configurational diagram illustrating one example of a license management model according to a third embodiment.

FIG. 12 is a block diagram illustrating one example of a configuration of a license management unit according to the third embodiment.

FIG. 13 is a configurational diagram illustrating one example of a license management model according to a fourth embodiment.

FIG. 14 is a block diagram illustrating one example of a configuration of a license management unit according to the fourth embodiment.

FIG. 15 is a flowchart illustrating one example of a license management method according to a fifth embodiment.

FIG. 16 is a configurational diagram illustrating one example of term-limited paid software.

FIG. 17 is a schematic diagram illustrating one example of an operation of an execution unit according to the second embodiment.

### DETAILED DESCRIPTION

In the following, preferred embodiments of the present invention will be described with reference to the appended drawings. In all drawings for illustrating the embodiments, the same numerals are assigned to the same parts in principle and repetitive description thereof is omitted in principle.

### First Embodiment

### License Management Model

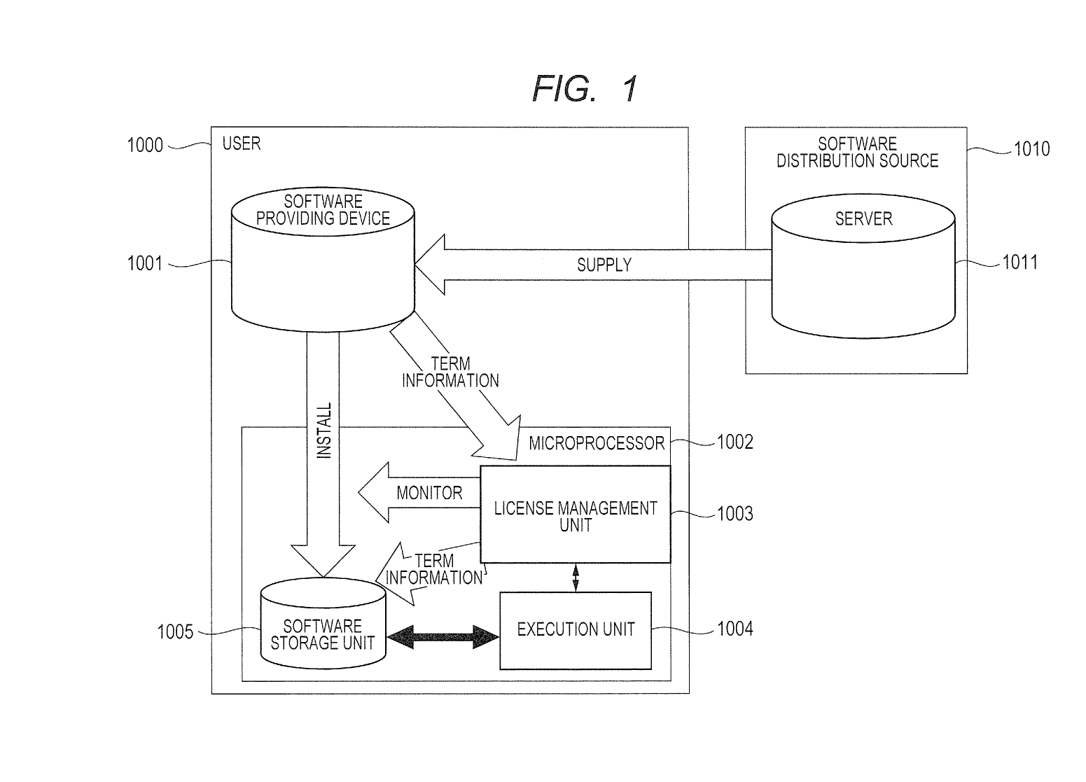

FIG. 1 is a configurational diagram illustrating one example of a license management model (a license management system) according to the first embodiment. In FIG. 1, 1000 denotes a user and 1010 denotes a seller such as a software distribution source and so forth who provides paid software.

In the first embodiment, although not limited in particular, the user 1000 purchases a semiconductor device, other electronic components (not illustrated) and so forth from an electronic component seller. The user 1000 designs, manufactures and sells an electronic device (not illustrated) by combining together the semiconductor device and the other electronic components that the user 1000 has purchased. As the electronic devices that the user 1000 sells, for example, personal computers, smartphones, printers, multifunction machines, TV sets, cameras and so forth may be given.

In the present specification, a microprocessor will be described as an example of the semiconductor device. A microprocessor denoted by 1002 is illustrated in FIG. 1. In order to make the microprocessor 1002 execute a desired operation, the user 1000 provides software from a software providing device 1001 to the microprocessor 1002. The software that is provided from the software providing device 1001 to the microprocessor 1002 includes software that the user 1000 has developed, free software, paid software, term-limited paid software and so forth. Although not limited in particular, the distribution source 1010 includes a server (a seller software providing device) 1011 that stores therein the software. For example, in response to a request from the user 1000, the software transmission of which is requested from the user 1000 is supplied from the server 1011 that the distribution source 1010 includes to the user 1000.

FIG. 1 illustrates one example of a case where the software that is supplied from the distribution source 1010 to the user 1000 is the term-limited software. The term-limited software that has been supplied from the distribution source 1010 is stored into the software providing device 1001 that the user 1000 includes. Incidentally, although FIG. 1 illustrates the case where the number of the software distribution sources is one, the software may be supplied from a plurality of the software distribution sources to the user 1000.

### <Configuration of Semiconductor Device (Microprocessor)>

The microprocessor 1002 includes an execution unit 1004 that executes the software concerned, a software storage unit 1005 coupled to the execution unit 1004, a license management unit 1003 and so forth. Although the microprocessor 1002 includes various units such as, for example, peripheral units adapted to transmit/receive signals between the microprocessor 1002 and the software providing device 1001 in addition to the above-mentioned units, illustration of these units is omitted in FIG. 1. These units are formed into one semiconductor chip by a well-known semiconductor manufacturing technology and the semiconductor chip so formed is then, although not limited in particular, encapsulated into one package. The seller who provides the semiconductor device provides the semiconductor device to the user 1000 in a state of being formed into one semiconductor chip or encapsulated into one package as one unit.

The execution unit 1004 reads the software out of the software storage unit 1005 and executes the software so read-out. Thereby, an operation according to the read-out software is performed by the microprocessor 1002. Incidentally, the execution unit 1004 timely performs data storage into the software unit 1005 and so forth in the course of executing the read-out software.

The software storage unit 1005 is configured by, for example, an electrically rewritable nonvolatile memory. In the first embodiment, a flash memory is used as the nonvolatile memory. The software that has been provided from the software providing device 1001 is written into the software storage unit 1005 by a not illustrated flash writer. As the flash writer, flash writers of various configurations are present. For example, the flash writer may be dedicated equipment of a USB memory type, an SD card type and so forth and may be configured by using a general-purpose personal computer.

When the term-limited paid software is provided from the software providing device 1001 to the microprocessor 1002, a software part to be executed by the execution unit 1004 is written into the software storage unit 1003 by the not illustrated flash writer. That is, the software part is installed into the software storage unit 1005. In addition, term information that indicates the term of the term-limited paid software is supplied to the license management unit 1003.

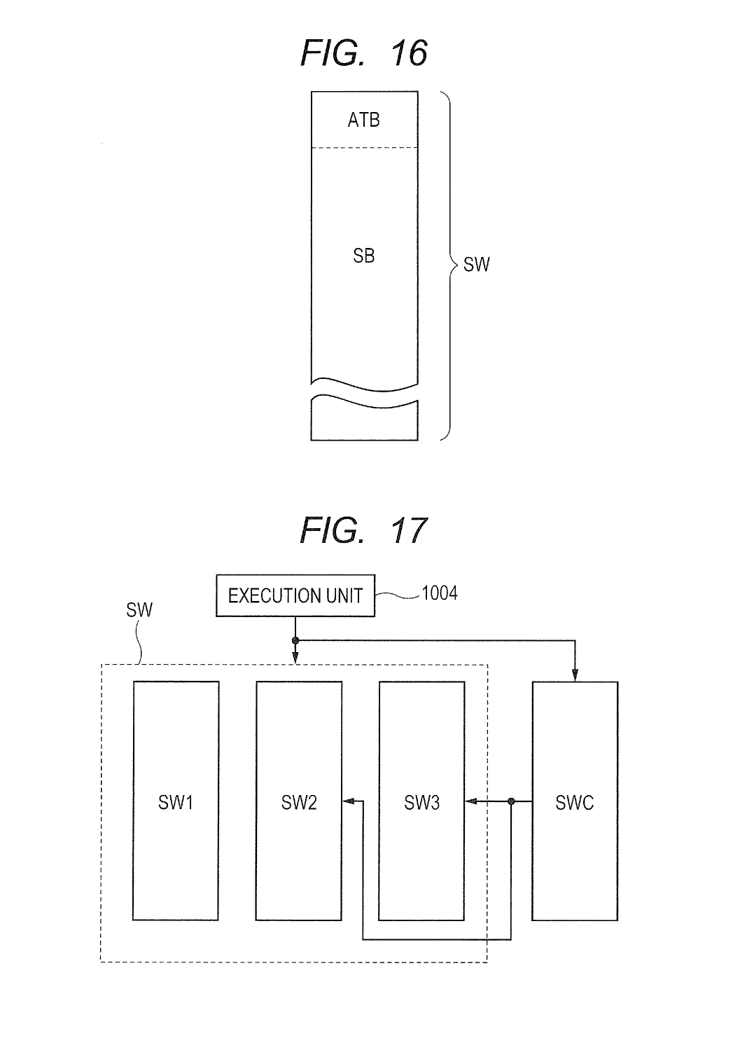

FIG. 16 is a configurational diagram illustrating one example of term-limited paid software SW. The term-limited paid software SW includes a software part SB and an attribute information part ATB. In the first embodiment, the term information that indicates the term of the term-limited paid software that is stored in the software part SB is stored in the attribute information part ATB. Here, the software that is stored in the software part SB is supplied as the term-limited paid software to be executed by the execution unit 1004. In the present specification, the term-limited paid software (the term-limited software) means both of the software SW illustrated in FIG. 16 and the software stored in the software part SB unless otherwise clearly stated in particular.

When the software that is provided from the software providing device 1001 is, for example, free software, the attribute information part ATB may not be included therein. It becomes possible to decide whether the software that has been provided from the software providing device 1001 is the paid software or the free software depending on whether the software includes the attribute information part ATB by configuring this way. The execution unit 1004 may execute this decision by software and/or the license management unit 1003 may execute this decision. When it has been decided that the software so provided includes the attribute information part ATB, the information stored in the attribute information part ATB is supplied to the license management unit 1003 and the software (the term-limited software) stored in the software part SB is supplied to and installed into the software storage unit 1005.

The term information to be stored into the attribute information part ATB indicates the term for which the license is granted. Therefore, the term information may be regarded to indicate a term (a valid term) for which the license is valid. In this case, the term information may be regarded as valid term information.

The license management unit 1003 controls execution of the term-limited software by the execution unit 1004 on the basis of the term indicated by the term information. That is, the license management unit 1003 permits execution of the term-limited software by the execution unit 1004 within the term (within the valid term) and inhibits execution of the term-limited software by the execution unit 1004 when the term is expired. The license management unit 1003 includes a time measuring function in order to perform management according to the elapsed time in this way.

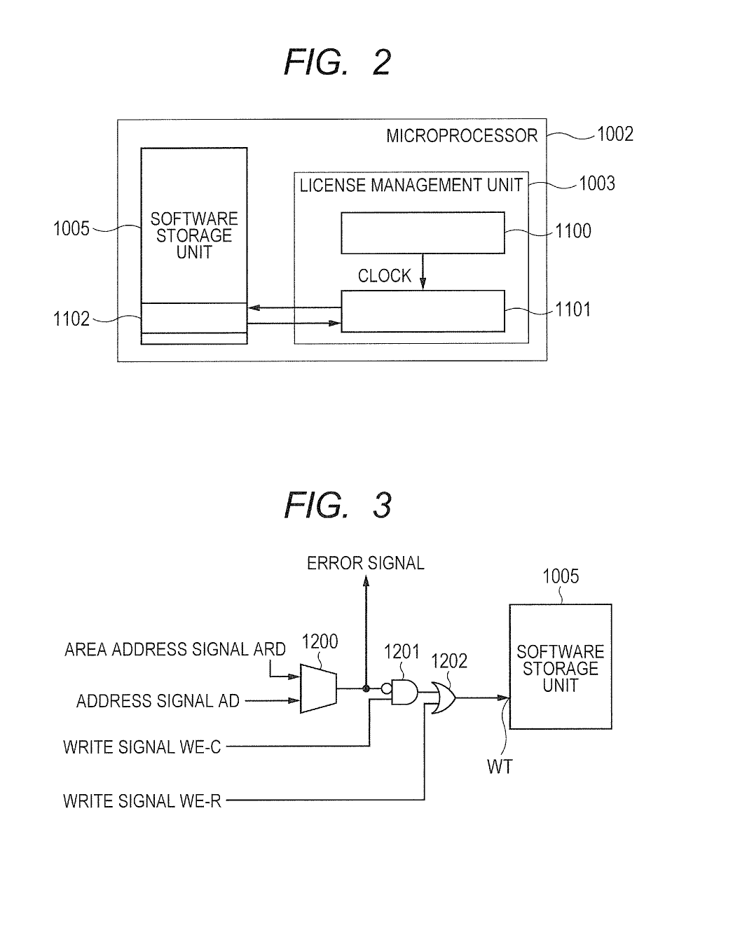

FIG. 2 is a block diagram illustrating one example of a configuration of the license management unit 1003 according to the first embodiment. In FIG. 2, also the software storage unit 1005 included in the microprocessor 1002 is illustrated in addition to the license management unit 1003. Although described later, in the first embodiment, a specific storage area of the software storage unit 1005 is used as a power-on time area 1102 in order to measure the elapsed time.

In FIG. 2, the license management unit 1003 includes a measurement circuit adapted to measure the elapsed time. The measurement circuit includes an oscillation circuit 1100, an increment circuit 1101 and so forth. The oscillation circuit 1100 oscillates in a predetermined cycle and supplies a clock signal (in FIG. 2, indicated as “CLOCK”) to the increment circuit 1101. The increment circuit 1101 is operated with the clock signal supplied from the oscillation circuit 1100. For example, when the clock signal shifts to a high-level signal, the increment circuit 1101 is operated. The increment circuit 1101 reads the power-on time information out of the power-on time area 1102 every time the increment circuit 1101 is operated, increases (increments) the power-on time information by, for example, one and writes (overwrites) the incremented power-on time information into the power-on time area 1102.

When the microprocessor 1002 has been powered on, for example, “0” is written into the power-on time area 1102 as the power-on time information. When the microprocessor 1002 is powered on, the oscillation circuit 1100 starts to perform an oscillation operation. Thereby, the power-on time information that is stored in the power-on time area 1102 is incremented as time elapses. That is, the power-on time information corresponding to the elapsed time, for example, up to the current time after powered-on is obtained. When highly accurate power-on time information is to be obtained, an oscillation circuit that uses a quartz resonator may be used as the oscillation circuit 1100. For cost saving, an oscillation circuit that uses, for example, a ring oscillator may be used as the oscillation circuit 1100. The oscillation circuit 1100 is not limited to the above-mentioned circuits and oscillation circuits of various configurations may be adopted.

The power-on time information is managed so as to indicate a sufficiently long time relative to a product life cycle of the microprocessor 1002. The power-on time information stored in the power-on time area 1102 is read out and incremented, and the power-on time information that has been updated by increment is written into the power-on time information 1102, for example, once a day. In this case, it becomes possible to obtain the power-on time information for forty-four years by configuring the power-on time area 1102 with fourteen bits. When the product life cycle of the microprocessor 1002 is, for example, ten years, it becomes possible to measure a time that is longer than the product life cycle by ensuring the 14-bit power-on time area 1102. When the product life cycle is longer than the above, it becomes possible to measure the elapsed time for about one hundred and eighty years by ensuring, for example, a 16-bit area as the power-on time area 1102.

“0” may be set as an initial value of the power-on time information into the power-on time area 1102 when the seller provides the microprocessor 1002 to the user 1000 or “0” may be set as the power-on time information when first piece of term-limited software has been installed. In addition, the power-on time information may be reset (0) or may not be changed when all pieces of the term-limited software have been uninstalled. Further, the increment circuit 1101 and the oscillation circuit 1100 may be configured to stop the operations when the term-limited software is not installed so as to promote a reduction in power consumption of the oscillation circuit 1100.

Although, in the first embodiment, description has been made such that the increment circuit 1101 increments the power-on time information in synchronization with the clock signal from the oscillation circuit 11100, the clock signal that the oscillation circuit 1100 generates may be divided such that the increment circuit 1101 increments the power-on time information in synchronization with a clock signal obtained by division.

When the term-limited software has been provided from the software providing device 1001 (FIG. 1), the license management unit 1003 acquires the term information from the attribute information part ATB, for example, as described with reference to FIG. 16. The license management unit 1003 obtains the valid term information that indicates the valid term of the term-limited software so provided by arithmetic operation on the basis of the acquired term information and the power-on time information stored in the power-on time area 1102 in the software storage unit 1005. The license management unit 1003 writes the valid term information that has been obtained by the arithmetic operation into a specific storage area in the software storage unit 1005.

In the software storage unit 1005, the above-mentioned power-on time area 1102 and the specific storage area that stores the valid term information are configured such that data in these areas are not changed by the execution unit (a central processing unit) 1004. The reason therefor is such that, here, when data changing is possible, unauthorized change of the term of the term-limited paid software may become possible. As configurations for making change of data in these areas impossible, various configurations are conceived. For example, when the microprocessor 1002 or the execution unit 1004 includes an MMU (Memory Management Unit), the MMU may be configured to protect the above-mentioned areas against an access made by the execution unit 1004.

In addition, as another configuration that makes it difficult for the execution unit 1004 to change data in these regions, such a protection unit as that, for example, illustrated in FIG. 3 may be added to the microprocessor 1002. FIG. 3 is a block diagram illustrating one example of part of the microprocessor 1002 according to the first embodiment. In FIG. 3, 1005 denotes the software storage unit illustrated in FIG. 1 and FIG. 2. The software storage unit 1005 is configured by the flash memory as described above.

Here, the outline of the flash memory that configures the software storage unit 1005 will be described. The flash memory includes an address terminal, a write terminal, a read terminal, a data terminal and so forth. An address signal is supplied to the address terminal and a high-level write signal is supplied to the write terminal, and thereby data that has been supplied from the data terminal is written into a storage area that is designated with the address signal that is supplied to the address terminal. In contrast, the address signal is supplied to the address terminal and a high-level read signal is supplied to the read terminal, and thereby the data stored in the storage area designated with the address signal that is supplied to the address terminal is output from the data terminal.

In the example in FIG. 3, the write terminal of the flash memory (hereinafter, the same numeral 1005 as that of the software storage unit will be assigned thereto) is designated by WT, and illustration of the address terminal, the read terminal and the data terminal is omitted. A protection unit includes a comparison circuit 1200, a NAND circuit 1201, an OR circuit 1202 and so forth.

An address signal AD sent from the execution unit 1004 and an area address signal ARD that designates the above-mentioned storage area are supplied to the comparison circuit 1200. Here, the area address signal ARD includes an area address signal that designates the power-on time area and an area address signal that designates the specific storage area that stores the valid term information. The comparison circuit 1200 outputs a high-level signal when the address signal AD designates the inside of the storage area designated with the area address signal ARD, and outputs a low-level signal when the address signal AD designates the outside of the storage area designated with the area address signal ARD.

An output signal from the comparison circuit 1200 is phase-inverted and supplied to the AND circuit 1201 and is also supplied to the execution unit 1004 as an error signal. When data is written into the flash memory 1005, the execution unit 1004 shifts a write signal WE-C to the high level signal. The write signal WE-C is supplied to the AND circuit 1201. When the address signal AD designates the outside of the storage area designated with the area address signal ARD, the error signal is shifted to the low-level signal and thereby that no error occurs is notified to the execution unit 1004. In addition, the output signal from the comparison circuit that has been shifted to the high-level by phase inversion and the high-level write signal WE-C are supplied to the AND circuit 1201. Therefore, an output signal from the AND circuit 1201 is shifted to the high-level signal, and this high-level output signal is supplied to the write terminal WT of the flash memory 1005 via the OR circuit 1202. Thereby, data writing into the flash memory 1005 becomes possible.

In contrast, when the address signal AD designates the inside of the storage area designated with the area address signal ARD, the error signal is shifted to the high-level signal and thereby that an error is occurring is notified to the execution unit 1004. In this case, the output signal from the comparison circuit 1200 that has been shifted to the low-level signal by phase inversion is supplied to the AND circuit 1201. In addition, since the high-level write signal WE-C is being generated from the execution unit 1004, the AND circuit 1201 outputs the low-level output signal at this time. In this case, the license management unit 1003 does not instruct data writing into the flash memory 1055. Therefore, at this time, the license management unit 1003 outputs a low-level write signal WE-R. Consequently, the OR circuit 1202 receives the low-level signal from the AND circuit 1201 and receives the low-level write signal WE-R from the license management unit 1003 and then the OR circuit 1202 supplies a low-level signal to the write terminal WT of the flash memory 1005. Consequently, data writing into the flash memory 1005 is not performed. That is, the storage area is protected against the access from the execution unit 1004 and data writing into the storage area designated with the area address signal ARD is inhibited.

On the other hand, when the license management unit 1003 has output the high-level write signal WE-R, the high-level write signal is supplied to the write terminal WT of the flash memory 1005 via the OR circuit 1202. Consequently, data writing into the flash memory 1005 becomes possible. That is, the license management unit 1003 is allowed to write data into the storage area that has been designated with the area address signal ARD and it becomes possible for the license management unit 1003 to write the power-on time information and the valid term information into the storage area in the flash memory 1005.

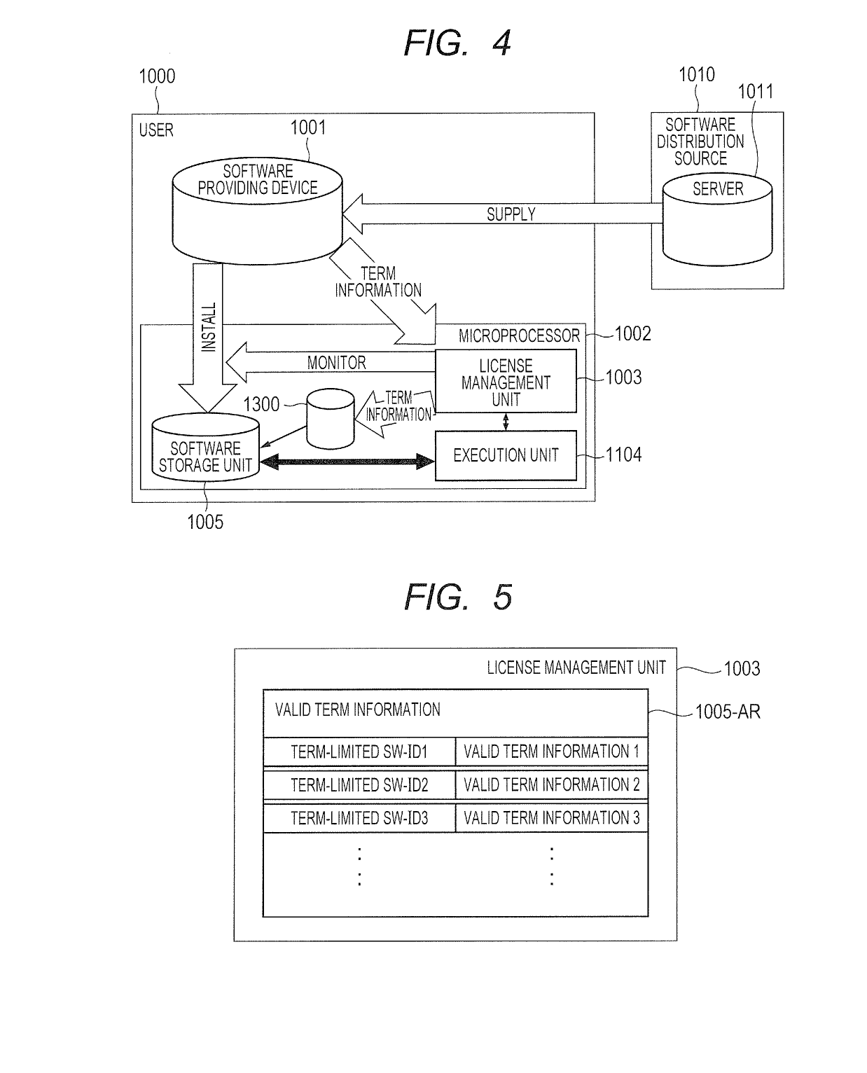

Further, one example of another configuration that prevents data in the specific storage area that stores the power-on time information and the valid term information from being changed by the execution unit 1004 is illustrated in FIG. 4.

Since the configuration in FIG. 4 is similar to that in FIG. 1, only different points will be described here. In FIG. 4, 1300 denotes a storage unit. The storage unit 1300 is not allocated to an address map of the execution unit 1004. In other words, the storage unit 1300 is not coupled to the execution unit q1004. The storage unit 1300 is coupled to the license management unit 1003, and the valid term information and the power-on time information are written from the license management 1003 into the storage unit 1300 and read out of the storage unit 1300. It becomes possible to make it difficult to write and read the valid term information and the power-on time information into and out of the storage unit 1300 from the execution unit 1004 and it becomes possible to implement high security against unauthorized acts such as falsification of the valid term and so forth.

Owing to the above-mentioned configurations, it becomes difficult for the execution unit 1004 to change data in the specific storage area that stores the valid term information and the power-on time information. However, it may become difficult to test whether the specific storage area normally operates in a process of manufacturing the microprocessor 1002. In order to test the operation of the specific storage area, it is requested to install a route through which data writing from the outside is possible. Configurations for installing the data writing route are as follows.

(1) It is made possible for the execution unit 1004 to execute a special instruction that is not disclosed to the user 1000. In this case, the configuration is made such that the execution unit 1004 operates so as to write data into the above-mentioned specific storage area only when the execution unit 1004 has executed the special instruction. Thereby, it becomes possible to perform a test on the above-mentioned specific storage area while promoting prevention of the unauthorized acts.

(2) When the execution unit 1004 has executed a special procedure, it is made possible for the execution unit 1004 to write the data into the above-mentioned specific storage area. In this case, the specific procedure is such that the execution unit 1004 accesses to a specific address in the fixed order or the execution unit 1004 writes or reads a specific code into or out of the specific address. Only when the execution unit 1004 has followed such a specific procedure as mentioned above, it is made possible for the execution unit 1004 to write data into the above-mentioned specific storage area.

(3) A route through which an access is made to the above-mentioned storage area directly from the outside with no intervention of the central processing unit 1004 is installed. In this case, the configuration is made such that the route is formed only after a specific serial code has been supplied from an external terminal (a pin) provided on the package such that the content of the above-mentioned specific storage area may not be falsified by the user 1000, or the test on the above-mentioned specific area is performed only at a wafer stage. In this case, the route to the above-mentioned specific storage area is not coupled to the external terminal (the pin) of the package and is fixed in the package.

It becomes possible to perform the test on the specific storage area while preventing the content of the above-mentioned specific storage area from being falsified by doing as mentioned above.

### <Valid Term Information>

In the first embodiment, the valid term information is stored into the specific storage area of the software storage unit 1005 (FIG. 1) or the storage unit 1300 (FIG. 4). The valid term information is written into the specific storage area of the software storage unit 1005 or the storage unit 1300 by the license management unit 1003 and is used in license management. Accordingly, the valid term information may be regarded as part of the license management unit 1003. Accordingly, description will be made on the assumption that the storage region that stores therein the valid term information is included in the license management unit 1003 in order to facilitate the description.

FIG. 5 is an explanatory diagram illustrating one example of a table relevant to the valid term information included in the license management unit 1003. It may be regarded such that the specific storage area of the software storage unit 1005 is illustrated in FIG. 5 as if it is included in the license management unit 1003. In this case, in FIG. 5, the specific storage area is denoted by 1005-AR. The specific storage area 1005-AR may be regarded as a storage area of the software storage unit 1005 to be designated with the area address signal ARD illustrated in FIG. 3. The table is formed in the specific storage area 1005-AR. Information that specifies the term-limited software and the valid term information of the term-limited software are stored in the table in pairs. Every time the term-limited software is installed into the software storage unit 1005, information that specifies the term-limited software so installed and the valid term information corresponding to the information that specifies the term-limited software so installed are added to the table.

As the information that specifies the term-limited software, for example, a unique signal (ID) that specifies the term-limited software is given. When the term-limited software does not include the specific unique number (ID), the unique number (ID) that specifies the term-limited software that is stored in the software part SB may be stored into, for example, the attribute information part ATB that has been described with reference to FIG. 16. Here, description will be made on the assumption that the unique number (IB) is stored in the attribute information part ATB. Incidentally, also in this case, also the term information that indicates the term is included in the attribute information part ATB.

The table that is formed in the storage area 1005-AR will be described with reference to FIG. 5 by way of example. The license management unit 1003 acquires the unique number (ID) and the term information that are stored in the attribute information part ATB from the term-limited software that has been provided from the software providing device 1001 and forms the table on the basis of the acquired information and the power-on time information. That is, when the term-limited software is provided, the license management unit 1003 arithmetically operates the term information that is stored in the attribute information part ATB and the power-on time information and forms the valid term information. The formed valid term information and the unique number (ID) that is stored in the attribute information part ATB are registered into the table in the storage area 1005-AR in pairs.

FIG. 5 illustrates one example that three pieces of term-limited software are registered in the table. In FIG. 5, “Term-Limited SW-ID1” denotes the unique number of term-limited software ID1 and “Valid Term Information 1” denotes the valid term information that has been obtained on the basis of the term information of the term-limited software ID1. In addition, “Term-Limited SW-ID2” denotes the unique number of term-limited software ID2 and “Valid Term Information 2” denotes the valid term information that has been obtained on the basis of the term information of the term-limited software ID2. Likewise, “Term-Limited SW-ID3” denotes the unique number of term-limited software ID3 and “Valid Term Information 3” denotes the valid term information that has been obtained on the basis of the term information of the term-limited software ID3.

Each piece of the valid term information is formed by adding the power-on time information to the term information stored in the attribute information part ATB. That is, the time indicated by the term information is added to the current time indicated by the current power-on time information as an offset and thereby the term counted with a power-on time being defined as a starting point is indicated by the valid term information. When taking “Valid Term Information 1” by way of example, the term information stored in the attribute information part ATB of the term-limited software ID1 and the current power-on time information are added together. Information obtained by adding the above-mentioned pieces of information is registered into the table as “Valid Term Information 1”. Likewise, in case of “Valid Term Information 2”, the term information stored in the attribute information part ATB of the term-limited software ID2 and the current power-on time information are added together. Information obtained by adding the above-mentioned pieces of information is registered into the table as “Valid Term Information 2”. Management of the term of the term-limited software ID1 becomes possible with a time that the term-limited software ID1 has been installed being defined as a starting point and management of the term of the term-limited software ID2 becomes possible with a time that the term-limited software ID2 has been installed being defined as a starting point, by doing as mentioned above.

In the table formed in the storage area 1005-AR, it is desirable to set a longest term on the item of the valid term information when the seller provides the microprocessor 1002 to the user 1000. For example, when all bits that configure the valid term information of the longest term are set to logical values “1s”, the microprocessor 1002 is provided in a state of setting all bits of each piece of the valid term information in the table to the logical values “1s”. Initialization of the item of the unique number of each piece of the term-limited software is eliminated by doing as mentioned above. That is, when the user 1000 has installed the software concerned and registered the unique number of the software into the item for the unique number, a state where substantially no limit is set on the term information of the software is attained. Therefore, it becomes possible to execute the software at first substantially with no limit without initializing the item of the unique number.

When the flash memory is used as the software storage unit 1005, there are cases where the flash memory has a zero purge function of setting all bits to the logical values “0s”. In this case, changing the logical values of the flash memory to the logical values “0s” is easier than changing to the logical values “1s”. In this case, setting may be changed so as to indicate the longest term when all bits of the valid term information are set to the logical values “0s”.

A valid bit that indicates whether the unique number and the valid term information that are registered are valid may be added to the table. In this case, each valid bit corresponding to each unique number is prepared. The valid bit is used such that, for example, when the logical value “1” is written into the prepared valid bit, the unique number and the valid term information that correspond to that valid bit are decided to be valid and are used for license management, on the other hand, when the valid bit has been cleared (set to the logical value “0”), the unique number and the valid term information that correspond to that valid bit are decided to be invalid and are not used for license management. It becomes possible to reduce the number of bits to be rewritten and it becomes possible to promote speeding-up in comparison with a case where the valid term information is initialized, by preparing the valid bits corresponding to the respective unique numbers in this way.

It has been described that the unique number (ID) is registered into the table in order to specify the term-limited software with reference to FIG. 5. However, the present invention is not limited to the configuration illustrated in FIG. 5. That is, the address of the term-limited software that has been installed may be registered in place of the unique number (ID). That is, the address of the term-limited software in the software storage unit 1005 may be registered in place of the unique number (ID). In this case, the address is registered into the table as an area address that indicates an area between a start address and an end address. It becomes possible for the license management unit 1003 to speed up control of execution of the term-limited software by the execution unit 1004 by registering the address of the software in place of the unique number (ID).

Although described later, when controlling execution of the term-limited software by the execution unit 1004, the license management unit 1003 compares information for specifying the term-limited software stored in the table with the address output from the execution unit 1004. When the unique number (ID) is registered in the table as the information for specifying the term-limited software, the address of the software is obtained from the unique number (ID) and the obtained address is compared with the address from the execution unit 1004. In contrast, when the address is used as the information for specifying the term-limited software, since all one has to do is to compare the address of the term-limited software registered in the table with the address from the execution unit 1004, it becomes possible to promote speeding-up of control of execution of the software.

In addition, management may be performed by setting such that the respective pieces of term-limited software installed in the software storage unit 1005 have the same valid term. In this case, no table is used and only the valid term information may be stored into the storage area 1005-AR.

### <Summary of Control of Execution of Term-Limited Software>

Next, configurations for controlling execution of the term-limited software will be described by using the table described with reference to FIG. 5. Here, two configurations will be described.

### <<First Configuration>>

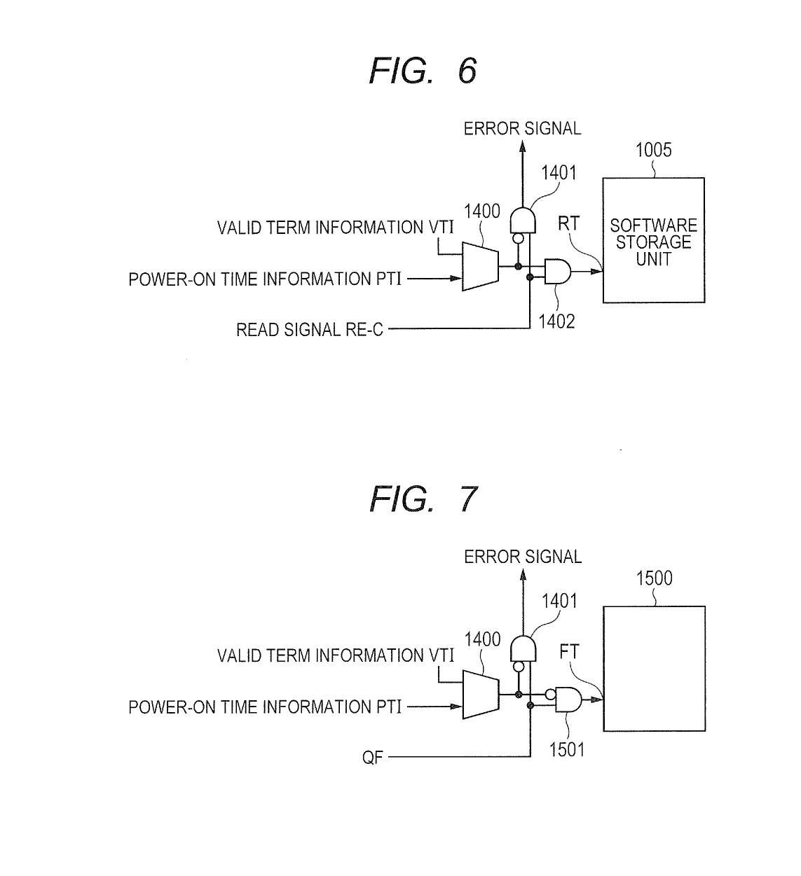

FIG. 6 is a block diagram illustrating one example of part of the license management unit 1003. In FIG. 6, 1005 denotes the flash memory that configures the software storage unit. Since the outline of the flash memory has already been described by using FIG. 3, description thereof is omitted here. Only the read terminal RT is illustrated in the terminals that the flash memory 1005 includes and illustration of other terminals is omitted in FIG. 6.

In FIG. 6, 1400 denotes a comparison circuit and 1401 and 1402 denote AND circuits. Although not limited in particular, the comparison circuit 1400 and the AND circuits 1401 and 1402 are included in the license management unit 1003.

The valid term information (valid term information VTI in FIG. 6) is supplied from the table illustrated in FIG. 5 to the comparison circuit 1400 and the power-on time information (power-on time information PTI in FIG. 6) is supplied from the power-on time area 1102 (FIG. 2) to the comparison circuit 1400. When the power-on time that is indicated by the power-on time information PTI exceeds the valid term indicated by the valid term information VTI, the comparison circuit 1400 shifts an output signal to the low-level signal. In contrast, when the power-on time that is indicated by the power-on time information PTI does not exceed (does not reach) the valid term indicated by the valid term information VTI, the comparison circuit 1400 shifts the output signal to the high-level signal. That is, the comparison circuit 1400 compares the current time (the time indicated by the power-on time information PTI) with the term (the time indicated by the valid term information VTI) with the power-on time being defined as a starting point. When the current time exceeds the term with the power-on time being defined as the starting point, the output signal from the comparison circuit 1400 is shifted to the low-level signal, and when the current time does not exceed the term, the output signal from the comparison circuit 1400 is shifted to the high-level signal.

The output signal from the comparison circuit 1400 is supplied to the AND circuit 1402 and is phase-inverted and supplied to the AND circuit 1401. In addition, the read signal RE-C is supplied from the execution unit 1004 to the AND circuits 1401 and 1402. An output signal from the AND circuit 1401 is supplied to the execution unit 1004 as an error signal, and an output signal from the AND circuit 1402 is supplied to a read terminal RT of the flash memory 1005 as the read signal.

The execution unit 1004 reads the software out of the flash memory 1005 and executes the software. At this time, the execution unit 1004 outputs the address signal AD that designates the address of the flash memory 1005 that the software to be read out is stored. In addition, in order to designate data reading to the flash memory 1005, the execution unit 1004 shifts the read signal RE-C to the high-level signal.

The license management unit 1003 searches the table that has been described using FIG. 5 on the basis of the address signal AD that the execution unit 1004 outputs. In the example in FIG. 5, a term-limited SW-ID that matches the unique number (ID) corresponding to the address signal AD concerned is searched from term-limited software IDs “Term-Limited SW-ID1” to “Term-Limited SW-ID3”. The valid term information that corresponds to the term-limited software ID that has been found by searching is supplied to the comparison circuit 1400 as the valid term information VT1. For example, when “Term-limited SW-ID1” has matched the unique number (ID) by searching, “Valid Term Information 1” that corresponds to “Term-Limited SW-ID1” is supplied to the comparison circuit 1400 as the valid term information VTI.

When the power-on time indicated by the power-on time information PTI exceeds the valid term indicated by the valid term information VTI, the output signal from the comparison circuit 1400 is shifted to the low-level signal. In this case, the execution unit 1004 outputs the high-level read signal RE-C in order to read the software out of the flash memory 1005. Therefore, the output signal from the AND circuit 1401 is shifted to the high-level signal, the high-level error signal is supplied to the execution unit 1004, and thereby that the error is occurring is notified to the execution unit 1004. In this case, since the low-level output signal is supplied from the comparison circuit 1400 to the AND circuit 1402, an output signal from the AND circuit 1402 is shifted to the low-level signal and the low-level read signal is supplied to the read terminal RT of the flash memory 1005.

The low-level read signal is supplied to the read terminal RT, and thereby a reading operation is not performed on the flash memory 1005 and software reading is not performed. That is, the term-limited software is not supplied from the flash memory 1005 to the execution unit 1004 and execution of the term-limited software is inhibited.

On the other hand, when the power-on time indicated by the power-on time information PTI does not exceed the valid term indicated by the valid term information VTI, the output signal from the comparison circuit is shifted to the high-level signal. Therefore, the output signal from the AND circuit 1401 is shifted to the low-level signal, the low-level error signal is supplied to the execution unit 1004 and thereby that the error does not occur is notified to the execution unit 1004. In this case, since the output signal from the comparison circuit 1400 is shifted to the high-level signal, the output signal from the AND circuit 1402 is shifted to the high-level signal and thereby the high-level read signal is supplied to the read terminal RT of the flash memory 1005.

The high-level read signal is supplied to the read terminal RT, and thereby the reading operation is performed on the flash memory 1005 and the term-limited software is read out of the storage area designated by the address signal AD output from the execution unit 1004. That is, the term-limited software is supplied from the flash memory 1005 to the execution unit 1004 and thereby execution of the term-limited software becomes possible.

Execution of the term-limited software by the execution unit 1005 is controlled by the license management unit 1003 on the basis of the term information in this way.

### <<Second Configuration>>

FIG. 7 is a block diagram illustrating one example of part of the license management unit 1003. In FIG. 7, 1500 denotes an instruction queue. Although, here, a case where the instruction queue 1500 is installed on the execution unit 1004 will be described, the instruction queue 1500 may be installed outside the execution unit 1004.

The execution unit 1004 includes the instruction queue 1500 and an execution part (not illustrated) that executes the instruction supplied from the instruction queue 1500. In this case, when the execution unit 1004 executes the software, the execution unit 1004 outputs an instruction fetch signal QF and sequentially stores instructions that configure the software to be executed into the instruction queue 1500. The plurality of instructions are stored into the instruction queue 1500, an instruction to be executed is selected from within the plurality of instructions stored in the instruction queue 1500 and supplied to the execution part and execution of the supplied instruction is performed by the execution part. In the first embodiment, the instruction queue 1500 includes a purge terminal FT. It is made possible to invalidate (purge) all of the instructions stored in the instruction queue 1500 with a purge control signal that is supplied to the purge terminal FT.

The license management unit 1003 includes the comparison circuit 1400, the AND circuit 1401 and so forth similarly to the first configuration. In addition, although in the first configuration, the license management unit 1003 includes the AND circuit 1402, in the second configuration, the license management unit 1003 includes an AND circuit 1501 having a phase inversion function on the input side thereof in place of the AND circuit 1402. The phase inversion function is attained by, for example, an inverter circuit. Further, in the second configuration, the instruction fetch signal GF is supplied to the AND circuits 1401 and 1501 in place of the read signal RE-C. In addition, an output signal from the comparison circuit 1400 is phase-inverted by the phase inversion function and is supplied to the AND circuit 1501. An output signal from the AND circuit 1501 is supplied to the purge terminal FT of the instruction queue 1500 as the purge control signal. The configurations of the comparison circuit 1400 and the AND circuit 1401 are the same as those in the first configuration.

When the instruction is to be stored into the instruction queue 1500, the execution unit 1004 shifts the instruction fetch signal QF to the high-level signal. In addition, the high-level purge control signal is supplied to the purge terminal FT of the instruction queue 1500 and thereby all of the instructions that the instruction queue 1500 stores therein are invalidated.

When the power-on time indicated by the power-on time information PT1 exceeds the valid term indicated by the valid term information VTI, the output signal from the comparison circuit 1400 is shifted to the low-level signal. In this case, the execution unit 1004 outputs the high-level instruction fetch signal QF in order to store the instruction into the instruction queue 1500. Consequently, the AND circuit 1401 outputs the high-level error signal and thereby notifies the execution unit 1004 of occurrence of the error. In this case, since the output signal from the comparison circuit 1400 is phase-inverted and the high-level output signal is supplied to the AND circuit 1501, the output signal from the AND circuit 1501 is shifted to the high-level signal and the high-level purge signal is supplied to the purge terminal FT of the instruction queue 1500.

The high-level purge signal is supplied to the purge terminal FT and thereby all of the instructions stored in the instruction queue 1500 are invalidated. Consequently, execution of the term-limited software is inhibited.

On the other hand, when the power-on time indicated by the power-on time information PTI does not exceed the valid term indicated by the valid term information VTI, the output signal from the comparison circuit 1400 is shifted to the high-level signal. Therefore, the output signal from the AND circuit 1401 is shifted to the low-level signal, the low-level error signal is supplied to the execution unit 1004 and thereby that no error occurs is notified to the execution unit 1004. In this case, since the output signal from the comparison circuit 1400 is phase-inverted and the low-level signal is supplied to the AND circuit 1501, the output signal from the AND circuit 1501 is shifted to the low-level signal and the low-level purge signal is supplied to the purge terminal FT of the instruction queue 1500.

The low-level purge signal is supplied to the purge terminal FT, and thereby the instruction stored in the instruction queue 1500 is not invalidated and is executed by the execution part. That is, execution of the term-limited software becomes possible.

Also in the second configuration, execution of the term-limited software by the execution unit 1004 is controlled by the license management unit 1003 on the basis of the term information in this way.

### <Configuration of License Management Unit>

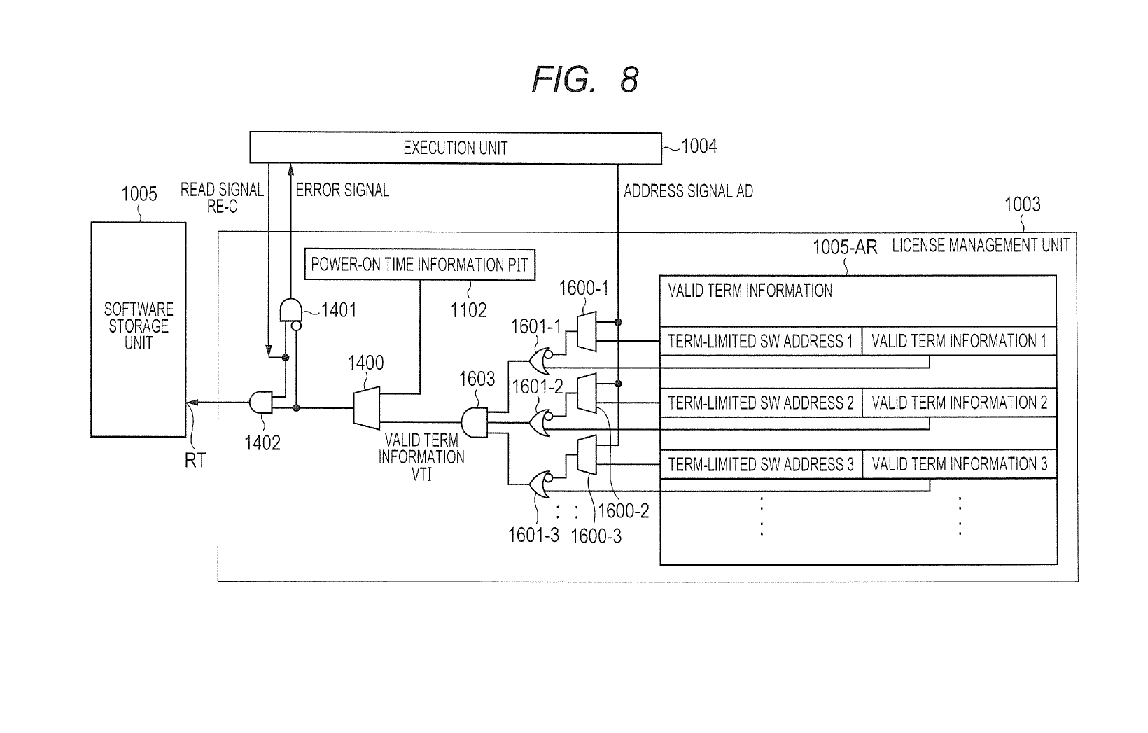

FIG. 8 is a block diagram illustrating one example of a configuration of the license management unit 1003 according to the first embodiment. In FIG. 8, also the execution unit 1004 and the software storage unit (the flash memory) 1005 are illustrated for the convenience of description. Here, a case where the license management unit 1003 has the first configuration that has been described with reference to FIG. 6 will be described.

Although in the first embodiment, the valid term information and the power-on time information are stored in the software storage unit 1005, the valid term information and the power-on time information are used by the license management unit 1003 in license management. Therefore, in FIG. 8, the specific storage area 1005-AR that stores the valid term information and a power-on time information area 1102 that stores the power-on time information are illustrated as areas that are included in the license management unit 1003.

First, the configuration of the license management unit 1003 will be described. The license management unit 1003 includes the specific storage area 1005-AR, the power-on time information area 1102, comparison circuit 1400 and 1600-1 to 1600-3, the two-input AND circuits 1401 and 1402, a three-input AND circuit 1603, two-input OR circuits 1601-1 to 1601-3 and so forth.

Since the two-input AND circuits 1401 and 1402 and the comparison circuit 1400 have already been described with reference to FIG. 6, detailed description thereof is omitted. In FIG. 8, it is clearly illustrated that the power-on time information PTI is supplied from the power-on time information area 1102 to the comparison circuit 1400. In addition, it is also clearly illustrated that the output signal from the two-input AND circuit 1401 is supplied to the execution unit 1004 as the error signal and the read signal RE-C is supplied from the execution unit 1004 to the two-input AND circuits 1401 and 1402. It is further clearly illustrated that the output signal from the two-input AND circuit 1402 is supplied to the read terminal RT of the flash memory 1005. Although each of the execution unit 1004 and the flash memory 1005 includes a plurality of terminals other than the terminals illustrated in FIG. 8, here, only terminals that are useful for description are clearly illustrated and illustration of the remaining terminals is omitted.

Although, in FIG. 5, one example that the unique number (ID) is used as the information for specifying the term-limited software to be stored into the specific storage area 1005-AR has been illustrated, one example that the address of the term-limited software that has been described with reference to FIG. 5 is used as the information for specifying the term-limited software is illustrated in FIG. 8. That is, the address of the term-limited software and the valid term information that indicates the valid term of the term-limited software are stored into the table in the specific storage area 1005-AR in pairs. In FIG. 8, a state where three pieces of the term-limited software have been registered in the table is illustrated.

That is, the address of term-limited software 1 in the flash memory 1005 is registered in the table as “Term-Limited SW Address 1” and the valid term information that indicates the valid term of the term-limited software 1 is registered in the table as “Valid Term Information 1”. In this case, “Term-Limited SW Address 1” and “Valid Term Information 1” are registered in one-to-one correspondence. In addition, the address of term-limited software 2 in the flash memory 1005 is registered in the table as “Term-Limited SW Address 2” and the valid term information that indicates the valid term of the term-limited software 2 is registered in the table as “Term-Limited Information 2”. In this case, “Term-Limited SW Address 2” and “Valid Term Information 2” are registered in one-to-one correspondence. Likewise, the address of term-limited software 3 in the flash memory 1005 is registered in the table as “Term-Limited SW Address 3” and the valid term information that indicates the valid term of the term-limited software 3 is registered in the table as “Valid Term Information 3”. Also, in this case, “Term-Limited SW Address 3” and “Valid Term Information 3” are registered in one-to-one correspondence.

Here, each piece of the valid term information 1 to 3 is information that indicates the valid term obtained by adding the power-on time obtained when the term-limited paid software has been installed into the flash memory 1005 to the term information included in the term-limited paid software as described with reference to FIG. 5. Therefore, for example, even when the terms of the respective pieces of term-limited paid software 1 to 3 are the same as one another, when timings that the respective pieces of term-limited paid software 1 to 3 have been installed into the flash memory 1005 are different from one another, the valid terms indicated by the respective pieces of valid term information 1 to 3 are made different from one another.

The comparison circuit 1600-1 and the two-input OR circuit 1601-1 are regarded as one unit logic circuit and correspond to one line of the table. That is, the comparison circuit 1600-1 and the two-input OR circuit 1601-1 respectively correspond to the term-limited SW address 1 and the valid term information 1 that are registered in one line of the table. Likewise, the comparison circuit 1600-2 and the two-input OR circuit 1601-2 are regarded as one unit logic circuit and correspond to one line of the table. That is, the comparison circuit 1600-2 and the two-input OR circuit 1601-2 respectively correspond to the term-limited SW address 2 and the valid term information 2 that are registered in one line of the table. In addition, the comparison circuit 1600-3 and the two-input OR circuit 1601-3 are regarded as one unit logic circuit and correspond to one line of the table. That is, the comparison circuit 1600-3 and the two-input OR circuit 1601-3 respectively correspond to the term-limited SW address 3 and the valid term information 3 that are registered in one line of the table. Output signals from the respective unit logic circuits, that is, the output signals from the two-input OR circuits 1601-1 to 1601-3 are supplied to the three-input AND circuit 1603 and an output signal from the three-input AND circuit 1603 is compared with the power-on time information PTI in the comparison circuit 1400.

The unit logic circuit is provided for each line of the table and the output signal from each unit logic circuit is supplied to the AND circuit 1603. Therefore, although in FIG. 8, description has been made assuming that the AND circuit 1603 is the three-input AND circuit, the AND circuit 1603 is an AND circuit having the number of input terminals corresponding to the number of lines of the table.

The address signal AD is supplied from the execution unit 1004 to one input terminal of each of the comparison circuits 1600-1 to 1600-3 and the term-limited SW address that is registered in the corresponding line of the table is supplied to the other input terminal of each of the comparison circuits 1600-1 to 1600-3. That is, the term-limited SW address 1 that is registered in the corresponding line of the table is supplied to the other input terminal of the comparison circuit 1600-1, the term-limited SW address 2 that is registered in the corresponding line of the table is supplied to the other input terminal of the comparison circuit 1600-2, and the term-limited SW address 3 that is registered in the corresponding line of the table is supplied to the other input terminal of the comparison circuit 1600-3.

Each of the comparison circuits 1600-1 to 1600-3 compares the address signal AD supplied to one input terminal with the term-limited SW address supplied to the other input terminal and shifts the output signal to the high-level signal when the address signal matches the address, and shifts the output signal to the low-level signal when the address signal does not match the address. Here, when the term-limited SW address indicates the address of an area that the term-limited paid software is stored, that is, when the term-limited SW address is an area address, each of the comparison circuits 1600-1 to 1600-3 shifts the output signal to the high-level signal when the address signal AD that is supplied to one input terminal designates in-range of the address that is supplied to the other input terminal, and shifts the output signal to the low-level signal when the address signal AD that is supplied to one input terminal designates out-of-range of the address that is supplied to the other input terminal.

Although not illustrated in FIG. 8, the address signal AD from the execution unit 1004 is also supplied to the address terminal of the flash memory 1005. The address signal AD is an instruction address signal that designates the address of an instruction in the software stored in the flash memory 1005 when the execution unit 1004 executes the software.

The output signal from each of the comparison circuits 1600-1 to 1600-3 is phase-inverted and is supplied to each of the corresponding two-input OR circuits 1601-1 to 1601-3. In addition, the valid term information that is registered in the corresponding line is supplied to each of the two-input OR circuits 1601-1 to 1601-3. That is, the valid term information 1 that is registered in the corresponding line is supplied to the two-input OR circuit 1601-1, the valid term information 2 that is registered in the corresponding line is supplied to the two-input OR circuit 1601-2, and the valid term information 3 that is registered in the corresponding line is supplied to the two-input OR circuit 1601-3.

When the execution unit 1004 executes the term-limited software, the execution unit 1004 outputs the address signal AD that designates the instruction in the term-limited software and shifts the read signal RE-C to the high-level signal. Each of the comparison circuits 1600-1 to 1600-3 in the license management unit 1003 compares the address signal AD from the execution unit 1004 with each of the term-limited SW addresses 1 to 3 registered in the corresponding lines. For example, when the address signal AD designates in-range of the address that is designated with the term-limited SW address 2, the output signal from the comparison circuit 1600-2 is shifted to the high-level signal and the output signal from each of the comparison circuits 1600-1 and 1600-3 is shifted to the low-level signal.

Consequently, the output signal from each of the two-input OR circuits 1600-1 and 1600-3 is shifted to the high-level signal. On the other hand, the output signal from the two-input OR circuit 1601-2 has a value according to the value of the valid term information 2. That is, while the valid term information 1 and the valid term information 3 are masked by the OR circuits 1601-1 and 1601-3, the valid term information 2 is transmitted to the AND circuit 1603 via the OR circuit 1601-2. The AND circuit 1603 supplies the transmitted valid term information 2 to the comparison circuit 1400 as the valid term information VTI.

The comparison circuit 1400 compares the power-on time indicated by the power-on time information PTI with the term (the valid term) indicated by the valid term information VTI as described with reference to FIG. 6. As described with reference to FIG. 6, when the power-on time exceeds the valid term as a result of comparison, the low-level read signal is supplied from the AND circuit 1402 to the read terminal RT of the flash memory 1005. Thereby, although the address signal AD is supplied from the execution unit 1004 also to the flash memory 1005, the software is not supplied from the flash memory 1005 to the execution unit 1004 and execution of the term-limited software is inhibited. In contract, when the power-on time does not exceed the valid term as the result of comparison, the high-level read signal is supplied from the AND circuit 1402 to the read terminal RT of the flash memory 1005. In this case, the instruction is read out of the flash memory 1005 in accordance with the address signal AD that is supplied from the execution unit 1004 to the flash memory 1005 and is supplied to the execution unit 1004. Consequently, execution of the term-limited software becomes possible.

Thereby, when the power-on time does not exceed the term on the basis of the term information of the term-limited software 2 that is registered in the table, execution of the term-limited software 2 by the execution unit 1004 is permitted, and when the power-on time exceeds the term, execution of the term-limited software 2 is inhibited.

Although description has been made by taking the term-limited software 2 by way of example, the same also applies to the term-limited software 1 and 3.

Incidentally, when the address signal AD that has been output from the execution unit 1004 designates out-of-range of the address that is designated with each of the term-limited SW addresses 1 to 3, each of the OR circuits 1601-1 to 1601-3 masks each piece of the valid term information 1 to 3 and each of the OR circuits 1601-1 to 1601-3 outputs the high level signal. Therefore, the high-level signal is supplied from the license management unit 1003 to the read terminal RT of the flash memory 1005. Consequently, the instruction according to the address signal AD is supplied from the flash memory 1005 to the execution unit 1004 and it becomes possible for the execution unit 1004 to execute the software.

When viewing the above-mentioned operation as a method of managing licenses, the license management method may be considered to include a process (a control process) of controlling execution of the term-limited software on which the license is granted with a term by the execution unit 1004 on the basis of the term information that indicates the term.

According to the first embodiment, it becomes possible for the user 1000 to execute the term-limited software that has been provided from the software distribution source 1010 via the communication line and so forth for the valid term indicated by the term information. Therefore, software distribution via the communication line leads to sales expansion of the paid software for the software distribution source 1010. In addition, the term for which execution of the term-limited paid software is possible may be regarded to be limited to the term indicated by the term information. Therefore, it becomes possible for the software distribution source 1010 to prevent the term-limited software from being used without due authorization beyond the valid term, with no management of the license after provided and it becomes possible to prevent omission of license fee collection while promoting load reduction. On the other hand, it becomes possible for the user 1000 to try the paid software before payment of the license fee and therefore it becomes possible to suppress useless expenses.

### Second Embodiment

In the first embodiment, the case where the license management unit 1003 is configured by using the hardware such as the comparison circuits 1400 and 1600-1 to 1600-3, the AND circuits 1401, 1402 and 1603, the OR circuits 1601-1 to 1601-3 and so forth has been described, for example, as described with reference to FIG. 8. However, the license management unit 1003 may be implemented by the software and the execution unit that execute the software. In addition, as the execution unit, the execution unit 1004 included in the microprocessor 1002 may be also used. When the license management unit 1003 is implemented by the execution unit 1004 and the software in this way, it is possible to suppress an increase in price of the microprocessor 1002.

FIG. 17 is a schematic diagram illustrating one example of an operation of the execution unit according to the second embodiment. In FIG. 17, 1004 denotes the execution unit described in the first embodiment. The execution unit 1004 executes pieces of software surrounded with a broken line SW and software SWC in time division. Here, SW1 in the broken line SW denotes free software, SW2 denotes paid software and SW3 denotes term-limited software. In addition, SWC denotes the software for implementing the function of the license management unit 1003. The execution unit 1004 is shared among these pieces of software SW1 to SW3 and SWC.

The execution unit 1004 executes the free software SW1, for example, at a first timing. In addition, the execution unit 1004 deals with the paid software SW2 at a second timing and deals with the term-limited software SW3 at a third timing. The execution unit 1004 reads the software SWC for implementing the function of the license management unit 1003 out of the software storage unit 1005 at the second timing and/or the third timing and executes the software SWC. For example, downloading of the paid software is controlled at the second timing and execution of the term-limited software is controlled at the third timing by executing the software SWC.

Even when a function related to the term is not incorporated into the term-limited software itself in observation of the term-limited software, it becomes possible to implement management based on the term for which the license is granted, by doing as mentioned above. That is, it becomes possible to implement management of terms related to the licenses without incorporating the function related to the term into each of the plurality of pieces of term-limited software. In addition, even when a function related to downloading is not incorporated into the paid software itself in observation of the paid software, license-based management becomes possible.

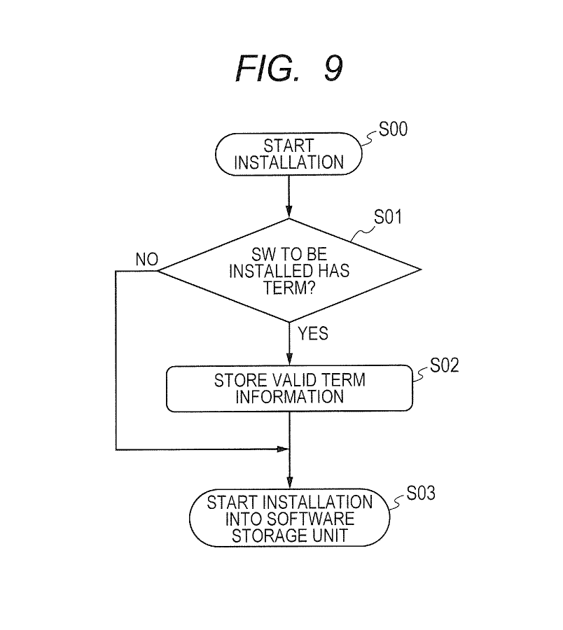

FIG. 9 is a flowchart illustrating one example of a function used when the term-limited software is to be installed into the software storage unit 1005 in functions that are implemented by the software SWC.

First, in step S00, installation of the software into the software storage unit 1005 is started. In step S01, the execution unit 1004 decides whether the software concerned is the term-limited software (SW) from the information that is stored in the attribute information part ATB of the software provided from the software providing device 1001 (FIG. 1). When the provided software does not include the attribute information part ATB or information stored in the attribute information part ATB does not indicate that the software is the term-limited software (no), the execution unit 1004 starts installation of the provided software in step S03.

On the other hand, in step S01, when it has been decided that the software (SW) to be installed is the term-limited software (yes), the execution unit 1004 then executes step S02. In step S02, the execution unit 1004 obtains the valid term information by addition of the term information and the power-on time information stored in the attribute information part ATB and stores (registers) the obtained valid term information into the table of the specific storage area 1005-AR. Step S02 may be regarded as a storage process of storing the term information. In addition, in this case, the address area when the software has been installed into the software storage unit 1005 is obtained from the software stored in the software part SB and is stored (registered) into the table of the storage area 1005-AR. In this case, the obtained address area (the term-limited SW address) and the valid term information are registered into the same line of the table so as to be in one-to-one correspondence in the table. Then, step S03 is executed.

The above-mentioned step S00 to step S03 are repetitively executed every time the software is provided from the software providing device 1001.

Thereby, the address area (the term-limited SW address) and the valid term information of the term-limited software are stored into the specific storage area 1005-AR in one-to-one correspondence similarly to that in the first embodiment.

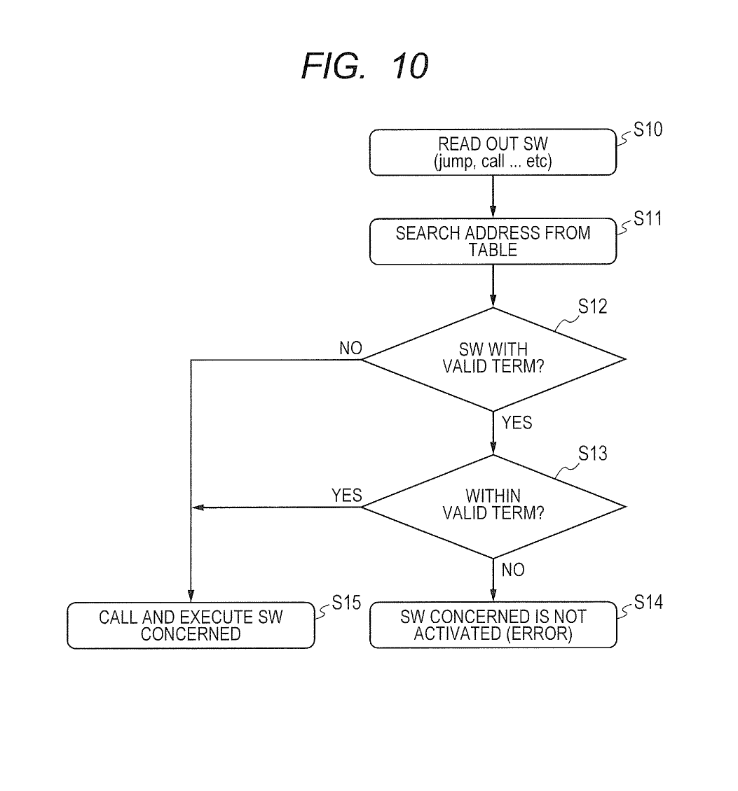

FIG. 10 is a flowchart illustrating one example of a function used when the term-limited software is to be executed (called) in the functions implemented by the above-mentioned software SWC.

In step S10, the execution unit 1004 detects execution or calling of the software. FIG. 10 illustrates a case where the software has been called out of another piece of software in response to an instruction. Incidentally, as call instructions, “jump”, “call” and so forth are exemplified in FIG. 10.

In step S11, the execution unit 1004 searches the table of the specific storage area 1005-AR on the basis of the called address. In this case, the execution unit 1004 checks the inside of any one of a plurality of address areas (the plurality of term-limited SW addresses) registered in the table to see whether the called address designates the area.

When the called address designates the inside of the address area in the search in step S11, it is decided that the software is the term-limited software (SW) (yes) in step S12 and then the execution unit 1004 executes step S13. In contrast, when the called address does not designate the inside of any address area, the execution unit 1004 decides that the software is not the term-limited term software (SW) in step S12 and then executes step S15.

In step S13, the execution unit 1004 reads the valid term information that is stored in one-to-one correspondence with the address area (the term-limited SW address) that includes the area designated by the called address out of the specific storage area 1005-AR and compares the valid term information with the power-on time indicated by the power-on time information. That is, the execution unit 1004 decides whether the term is within the valid term. When the term exceeds the valid term (no) as a result of decision, the execution unit 1004 then executes step S14. On the other hand, when the term does not exceed the valid term (yes), the execution unit 1004 then executes step S15.

In step S15, the execution unit 1004 calls and executes the software. In addition, in step S14, the execution unit 1004 notifies of occurrence of the error without executing (activating) the software.

Thereby, when the called software is the term-limited software and the term exceeds the valid term, step S14 is executed and execution of the term-limited software is inhibited. On the other hand, when the called software is not the term-limited software or the called software is the term-limited software and the term does not exceed the valid term, step S15 is executed. When the software is to be called or executed, execution of the above-mentioned steps is repeated.

The valid term information is obtained on the basis of the term information. Therefore, when viewing the above-mentioned operation as the license management method, step S11 to step S13 may be regarded as the control process of controlling execution of the term-limited software on the basis of the term information.

Incidentally, although the examples that the address area (address) is used as the information for specifying the term-limited software have been illustrated in FIG. 9 and FIG. 10, it goes without saying that also the unique number (ID) may be used.

In addition, in the second embodiment, management relevant to the licenses of the paid software SW2 and/or the term-limited paid software SW3 is implemented by the software SWC. Therefore, when the software is configured as the paid software or the term-limited paid software, it is possible to reduce or eliminate addition of functions relevant to license management. Thereby, it becomes possible for the software distribution source to reduce loads exerted in preparation of the software when the software is configured as the paid software and/or the term-limited paid software.

### Third Embodiment

In the first and second embodiments, execution of the term-limited paid software is possible within the term that is set for the software. Here, an embodiment that the term of the term-limited software that has been provided from the software distribution source (the seller) to the user is extended will be described. In the third embodiment, an example that the software distribution source distributes software used for term extension (hereinafter, referred to as software for term extension), the user executes the provided software for term extension, and thereby term extension is performed will be described.

As a situation that the term of the term-limited software is to be extended, a plurality of cases are conceivable. For example, there are cases as follows. First, the cases are broadly divided into a case where a request for term extension has been made from the user and a case where the software distribution source itself extends the term.

As the request for term extension made by the user, a case where payment of the license fee that is an equivalent for the license of the term-limited paid software has been made is conceived. On the other hand, as the case where the software distribution source itself extends the term of the software concerned, a case where a sales campaign will be made, a case where the software will be improved and so forth are conceived. In the sales campaign, the software for term extension is provided in order to extend the term for sales promotion of the software. In addition, for improvement of the software, the software for term extension is provided when a malfunction has occurred in the already distributed software or when improvement of performance of the software has been promoted. In this case, the software distribution source distributes (provides) also the improved term-limited software to the user.

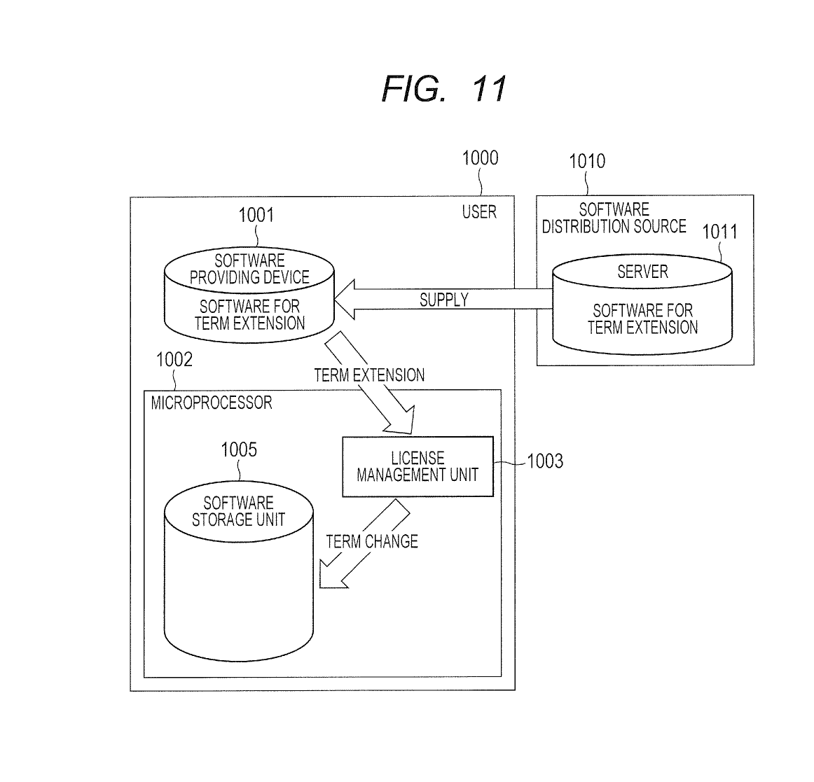

FIG. 11 is a configurational diagram illustrating one example of a license management model (a license management system) according to the third embodiment. Since the configuration in FIG. 11 is similar to that in FIG. 1, different points will be mainly described here. The software for term extension is stored in the server 1011 of the software distribution source 1010. In response to the request from the user 1000, the software for term extension is provided (supplied) from the server 1011 of the software distribution source 1010 to the user 1000 via, for example, the communication line and so forth. The provided software for term extension is stored into the software providing device 1001 that the user 1000 includes. In case of the third embodiment, although not limited in particular, the software for term extension that the software distribution source 1010 provides to the user 1000 includes information for specifying the term-limited paid software to be term-extended and term information that indicates a new valid term or an extended period. As the information for specifying the term-limited paid software to be term-extended, the unique number (ID) that has been described before with reference to FIG. 5 and/or the address (the area address) of the term-limited software that has been described with reference to FIG. 8 may be used. Here, a case where the area address is used as the information for specifying the term-limited software will be described by way of example.

The microprocessor 1002 receives the software for term extension from the software providing device 1001 and installs the software therein. In this case, the software for term extension is not stored into the software storage unit 1005 and is supplied to the license management unit 1003, differently from the term-limited paid software (in FIG. 11, indicated as “Term Extension”). The license management unit 1003 searches the table formed in the specific storage area 1005-AR in the software storage unit 1005 on the basis of area address of the term-limited software included in the supplied software for term extension. The license management unit 1003 changes the term of the term-limited software that has matched the software concerned in address matching to the valid term or the extended period included in the supplied software for term extension.

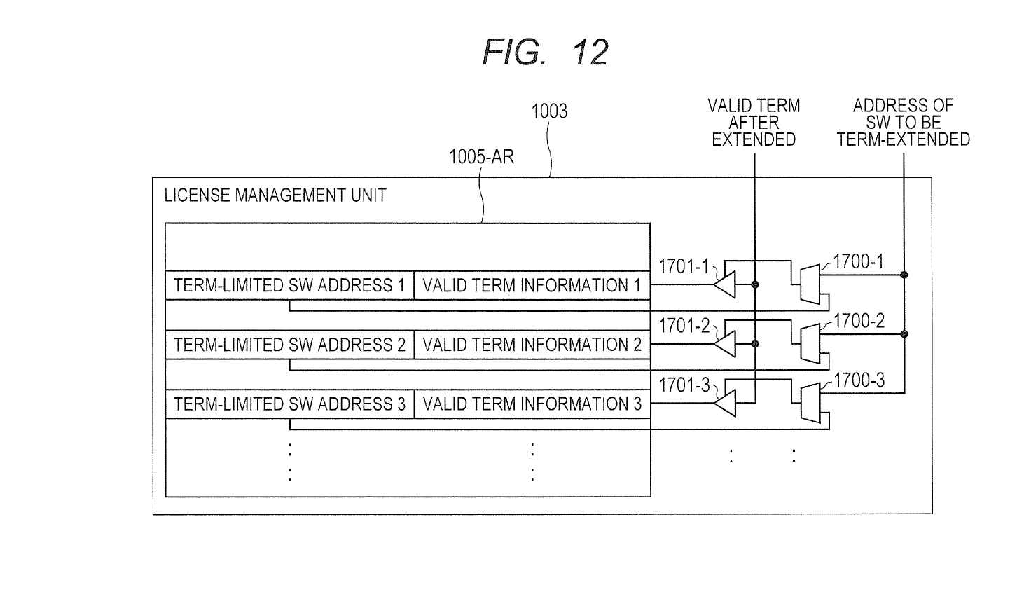

FIG. 12 is a block diagram illustrating one example of a configuration of the license management unit 1003 according to the third embodiment. In FIG. 12, the specific storage area 1005-AR of the software storage unit 1005 is illustrated as the area to be included in the license management unit 1003 similarly to the specific storage area 1005-AR in FIG. 8. The table is formed in the specific storage area 1005-AR, similarly to the table in FIG. 8. Since the configuration of the table is the same as that in FIG. 8, description thereof is omitted.

In FIGS. 12, 1700-1 to 1700-3 denote comparison circuits and 1701-1 to 1701-3 denote buffer circuits with control terminals. Each of the comparison circuits 1700-1 to 1700-3 compares the area address (in FIG. 12, indicated as “Address of SW to be Term-Extended”) with the address (in FIG. 12, indicated as “Term-Limited SW Address”) of the term-limited software registered in the corresponding line of the table. Each of the comparison circuits 1700-1 to 1700-3 supplies a control signal for activating each of the corresponding buffer circuits 1701-1 to 1701-3 to the control terminal of each of the corresponding buffer circuits 1701-1 to 1701-3 when the area address included in the software for term extension has matched the address of the term-limited software that is registered in the corresponding line of the table.

A valid term that has been extended in accordance with the valid term (or the extended period) included in the software for term extension is supplied to each of the buffer circuits 1701-1 to 1701-3. The control signal for activation is supplied from each of the corresponding comparison circuits 1700-1 to 1700-3 to each of the buffer circuits 1701-1 to 1701-3 and thereby each of the buffer circuits 1701-1 to 1701-3 stores the extended valid term so supplied into the corresponding line as the valid term information. For example, when the area address included in the software for term extension has matched the address 1 (in FIG. 12, “Term-Limited SW Address 1”) for specifying the term-limited software 1, the buffer circuit 1701-1 is activated. The activated buffer circuit 1701-1 registers the extended valid term so supplied as the valid term information 1 into the table. In this case, since each of the buffer circuits 1701-2 and 1701-3 is not activated, other pieces of the valid term information 2 and 3 are not changed.

The license management unit 1003 calculates the extended valid term on the basis of the valid term or extended period included in the supplied software for term extension and the valid term information (for example, the valid term information 1) to be term-changed and supplies the valid term so calculated as the extended valid term. That is, the license management unit 1003 reads out the valid term information 1, adds the valid term (the extended period) included in the software for term extension to the valid term indicated by the read-out valid term information 1, and thereby forms the extended valid term. Thereby, it becomes possible to continue management in the valid term set with the power-on time being defined as a starting point.

Even when the term of the term-limited software to be term extended has already exceeded the valid term when the software for term extension has been provided, extension of the valid term thereof is possible. Therefore, it becomes possible to revive and execute also the term-limited software whose term has already exceeded the valid term by using the software for term extension.

Although an example that the software for term extension includes the area address has been described, when the unique number (ID) is included, the unique number (ID) may be converted into the area address in the license management unit 1003.

In addition, in case of occurrence of the malfunction and so forth in the already provided term-limited software, also the improved term-limited software is provided. In this case, the improved term-limited software is supplied to and stored into the software storage unit 1005.

When viewing the above-mentioned operation as the license management method, a process of extending the term using the term information included in the software for term extension may be regarded as a term extension process.

Since in the third embodiment, it is possible to extend the period that the term-limited software is continuously used without again installing the software for term extension, it is possible to reduce the load exerted when the software for term extension is again installed and it is possible to improve convenience of the user 1000.

### Fourth Embodiment

In the third embodiment, an embodiment relating to extension of the valid term of the term-limited paid software has been described. Next, in the fourth embodiment, an embodiment relating to cancellation of the valid term will be described. For example, the user pays the equivalent that is requested for granting of the paid software to the software distribution source. The software distribution source receives the license fee as the equivalent and thereby the software distribution source provides (supplies) software (hereinafter, also referred to as software for term cancellation) used for cancelling the term of the term-limited paid software to the user. It goes without saying that the equivalent may be regarded as the balance between term-free paid software and the term-limited paid software.

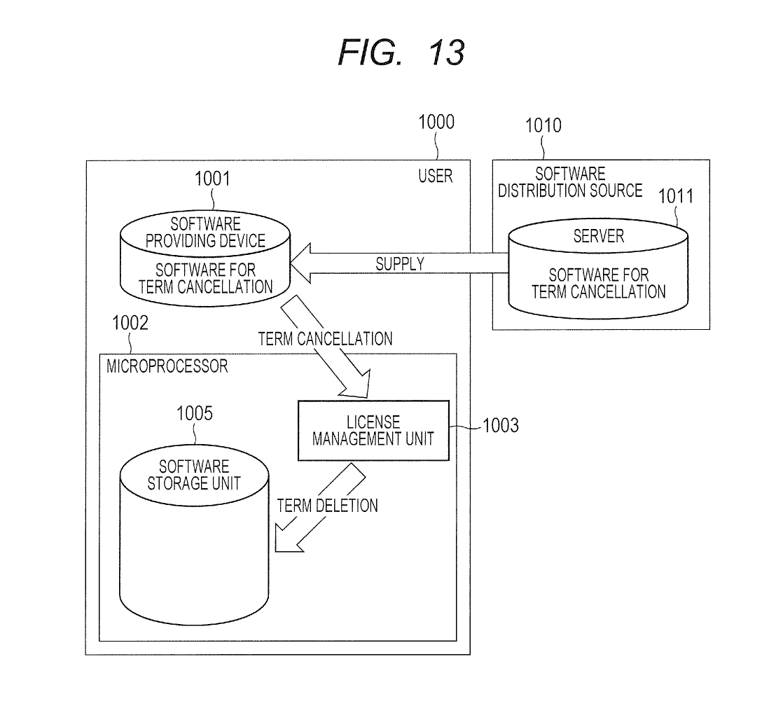

FIG. 13 is a configurational diagram illustrating one example of the license management model (the license management system) according to the fourth embodiment. Since the configuration in FIG. 13 is similar to that in FIG. 11, only different points will be mainly described here. The software for term cancellation is stored in the server 1011 of the software distribution source 1010. In response to payment of the equivalent from the user 1000, the software for term cancellation is provided (supplied) from the server 1011 of the software distribution source 1010 to the user 1000 via, for example, the communication line and so forth. The provided software for term cancellation is stored into the software providing device 1001 that the user 1000 includes. In the fourth embodiment, although not limited in particular, the software for term cancellation that the software distribution source 1010 provides to the user 1000 includes information for specifying the term-limited paid software to be term-cancelled and cancellation information indicating that the software concerned is the software for term cancellation. As the information for specifying the term-limited paid software to be term-cancelled, the unique number (ID) that has already been described with reference to FIG. 5 and/or the area address of the term-limited software that has been described with reference to FIG. 11 may be used. Here, a case where the area address is used as the information for specifying the term-limited software will be described by way of example.

The microprocessor 1002 receives the software for term cancellation from the software providing device 1001 and installs the received software therein. In this case, the software for term cancellation is not stored into the software storage unit 1005 and is supplied to the license management unit 1003, differently from the term-limited paid software (in FIG. 13, indicated as “Term Cancellation”). The license management unit 1003 searches the table formed in the specific storage area 1005-AR in the software storage unit 1005 on the basis of the area address of the term-limited software included in the supplied software for term cancellation. Through this search, the license management unit 1003 changes the term of the term-limited software that has matched the software concerned in address matching.

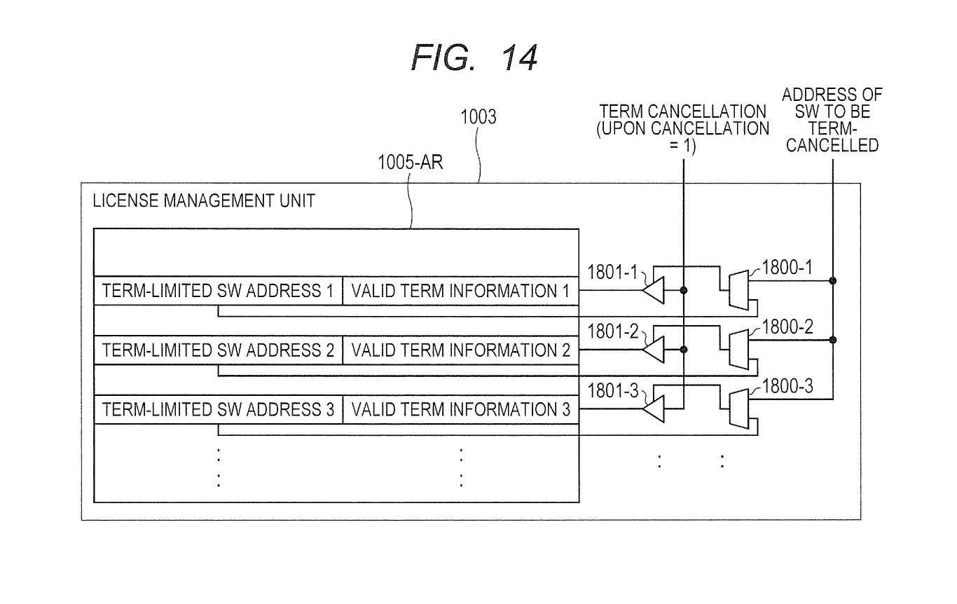

FIG. 14 is a block diagram illustrating one example of a configuration of the license management unit 1003 according to the fourth embodiment. In FIG. 14, the storage area 1005-AR of the software storage unit 1005 is illustrated as the area to be included in the license management unit 1003 similarly to the area in FIG. 8. The table is formed in the storage area 1005-AR, similarly to the table in FIG. 8. Since the configuration of the table is the same as that in FIG. 8, description thereof is omitted,

In FIGS. 14, 1800-1 to 1800-3 denote comparison circuits and 1801-1 to 1810-3 denote OR circuits. Each of the comparison circuits 1800-1 to 1800-3 compares the area address (in FIG. 14, denoted as “Address of SW to be Term-Cancelled”) with the address (in FIG. 14, denoted as “Term-Limited SW Address”) of the term-limited software that is registered in the corresponding line of the table. Each of the comparison circuits 1800-1 to 1800-3 supplies the logic value “1” to each of the corresponding OR circuits 1801-1 to 1801-3 when the area address included in the software for term cancellation has matched the address of the term-limited software that is registered in the corresponding line.

A term cancellation signal of the logic value “1” (in FIG. 14, denoted as “Term Cancellation (Upon Cancellation=1)”) is supplied to each of the OR circuits 1801-1 to 1801-3 in accordance with cancellation information included in the software for term cancellation. The logic value “1” is supplied from each of the corresponding comparison circuits 1800-1 to 1800-3 to each of the corresponding OR circuits 1801-1 to 1801-3 and thereby each of the OR circuits 1801-1 to 1801-3 stores the logic value “1” into the corresponding line of the table as the valid term information. For example, when the area address included in the software for term cancellation has matched the address 1 (in FIG. 14, “Term-Limited SW Address 1”) of the term-limited software for specifying the term-limited software 1, the OR circuit 1801-1 registers the logic value “1” as the valid term information 1 into the table. In this case, since the logic value “0” is supplied from each of the comparison circuits 1800-2 and 1800-3, each of the OR circuits 1801-2 and 1801-3 does not change each piece of the valid term information 2 and 3.

The license management unit 1003 specifies the term-limited software to be term-cancelled on the basis of the area address included in the supplied software for term cancellation and changes the values of all bits of the valid term information (for example, the valid term information 1) corresponding to the specified term-limited software to the logic values “1s”. As described in <Valid Term Information> in the first embodiment, it becomes possible to maximize the valid term of the term-limited software 1 corresponding to the valid term information 1 by changing the values of all bits of the valid term information to the logic values “1s”. That is, it is possible to substantially cancel the valid term of the term-limited software.

Cancellation of the valid term of the term-limited software to be term-cancelled is possible even though the term has already exceeded the valid term when the software for term cancellation has been provided. Therefore, it is possible to revive and execute also the term-limited software whose term has already exceeded the valid term by using the software for term cancellation.

Although an example that the software for term cancellation includes the area address has been described, when the unique number (ID) is included, the unique number (ID) may be converted into the area address in the license management unit 1003.

When viewing the above-mentioned operation as the license management method, a process performed by the software for term cancellation may be regarded as a term cancellation process of cancelling the term indicated by the term information.

### Fifth Embodiment

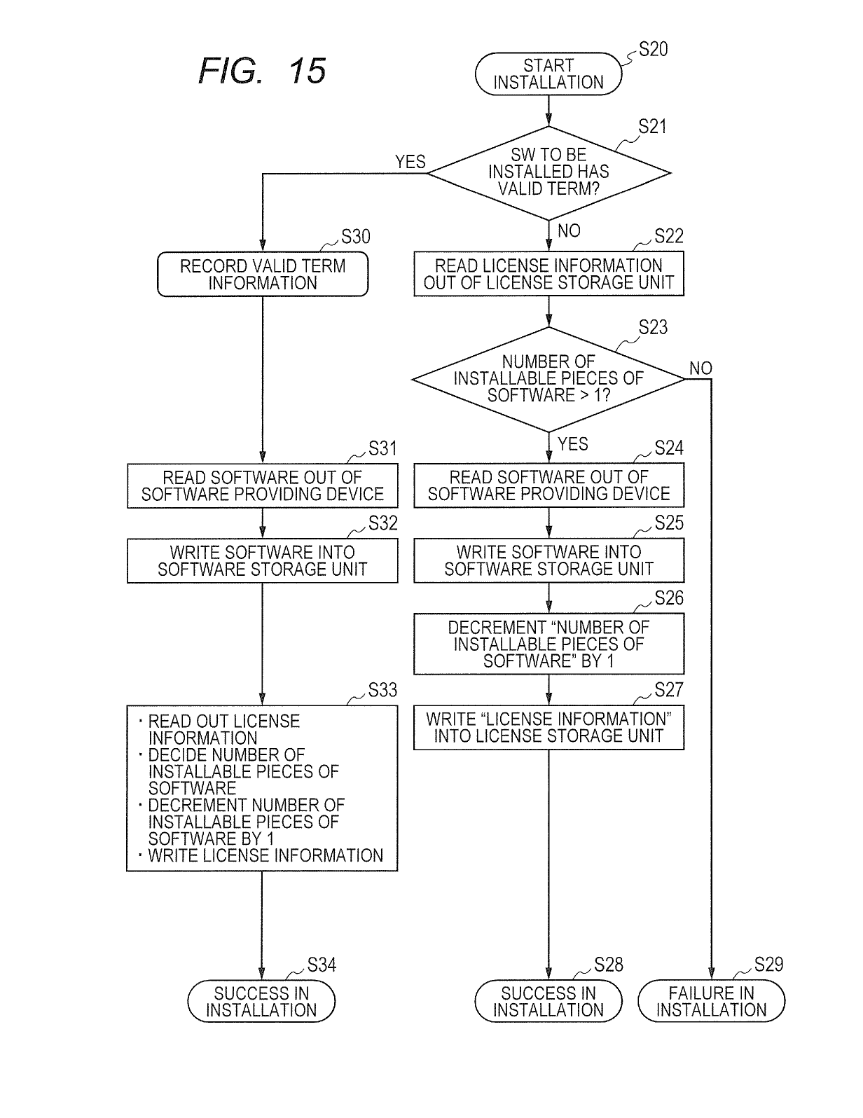

FIG. 15 is a flowchart illustrating one example of the license management method according to the fifth embodiment. The configuration of the microprocessor according to the fifth embodiment is similar to that of the microprocessor 1002 illustrated in FIG. 1. The microprocessor according to the fifth embodiment is different from the microprocessor 1002 illustrated in FIG. 1 in the configuration of the license management unit 1003. Although not illustrated in the drawing, hereinafter the microprocessor according to the fifth embodiment will be referred to as a microprocessor 1002-C. In addition, although not illustrated in the drawing, hereinafter the license management unit according to the fifth embodiment will be referred to as a license management unit 1003-C.

The license management unit 1003-C is configured by adding the following functions to the license management unit 1003 described in the first embodiment. That is, the license management unit 1003-C further includes a software decision unit, a license storage unit, a license control unit that controls storage (installation) of the software into the software storage unit 1005 and so forth.

License information according to the number of licenses of the paid software that the seller (a manufacturer) who sells the microprocessor 1002-C grants is written into the license storage unit prior to provision of the microprocessor 1002-C and then the microprocessor 1002-C is sold to the user 1000. In this case, the selling price of the microprocessor 1002-C is an amount of money obtained by adding the license fee corresponding to the number of licenses indicated by the license information to the price of the hardware of the microprocessor 1002-C.

The number of licenses indicates the number of pieces of paid software that are installable into the microprocessor 1002-C. Here, the number of licenses does not indicate the number of licenses that are installable into one piece of the paid software and indicates the number of mutually different kinds of paid software that are installable into one microprocessor. Therefore, it means that when purchasing the microprocessor 1002-C, the user 1000 pays the license fee for the licenses of the number indicated by license information, with the license fee being included into the purchase price (the selling price) of the microprocessor 1002-C, that is, the license fee is prepaid.

The software decision unit decides whether the software provided from the software providing device 1001 includes the attribute information part ATB (FIG. 16). When the provided software does not include the attribute information part ATB, the software decision unit decides that the provided software is free software. On the other hand, when the provided software includes the attribute information part ATB, the software decision unit decides whether the attribute information part ATB includes the term information related to the term. When the attribute information part ATB includes the term information related to the term, the software decision unit decides that the provided software is the term-limited paid software. In addition, when the term information is not included, the software decision unit decides that the provided software is the paid software. In this case, it means that the paid software is not software on which the license is granted for a predetermined term, differently from the term-limited paid software, and is paid software installation of which would not be allowed unless otherwise the license is granted.

The license control unit operates when the software decision unit has decided that the provided software is the paid software. That is, in case of the paid software, it is decided whether the number of installable pieces of software that is determined in accordance with the number of licenses indicated by the license information stored in the license management unit is at least one, and when the number of installable pieces of software is at least one, storage of the paid software concerned into the software storage unit 1005 is permitted, the number of installable pieces of software is decremented by one, and the number of installable pieces of software obtained by decrement is stored into the license storage unit as the license information. That is, the license information stored in the license storage unit is updated. In other words, when the number of licenses indicated by the license information is at least a predetermined number of licenses (1), installation of the paid software is made possible. When the paid software has been installed, the number of licenses is decremented and the license information that indicates the decremented number of licenses is stored into the license storage unit.

In contrast, when the number of installable pieces of software (corresponding to the number of licenses) that is indicated by the license information is less than one (less than the predetermined number of licenses), the license control unit inhibits storage of the paid software concerned into the software storage unit 1005. While it is made possible for the execution unit 1004 to execute the paid software that has been stored into the software storage unit 1005, the paid software that has not been stored into the software storage unit 1005 is not executed by the execution unit 1004.

The license information is updated every time the software decision unit decides that the provided software is the paid software. Thereby, although it is possible to execute the paid software until its number reaches the number of licenses indicated by the license information, execution of the paid software of the number exceeding the number of licenses indicated by the license information is inhibited.

Next, one example of a license managing operation according to the Fifth embodiment will be described with reference to FIG. 15. In step S20, installation of software is started. In step S21, the software decision unit in the license management unit 1003-C decides whether the software to be installed is free software, paid software or term-limited paid software. Since license management is performed on the paid software and the term-limited paid software, the process to be performed when the software concerned has been decided to be the free software is not illustrated in FIG. 15. Incidentally, in the flowchart in FIG. 15, “VALID TERM SET FOR SW TO BE INSTALLED?” is described in step S21.

In step S21, when it has been decided that the software is the software for which the valid term is set, that is, the term-limited software (yes), the license management unit 1003-C then executes step S30. In step S30, as described in the first embodiment and the second embodiment, the address of the term-limited software concerned and the valid term information obtained by arithmetic operation are registered (stored) into the table formed in the specific storage area 1005-AR in the software storage unit 1005. In the flowchart in FIG. 15, “RECORD VALID TERM INFORMATION” is described in step S30.

Then, in step S31, the software (the term-limited software) is read out of the software providing device 1001, and in step S32, the software (the term-limited software) is written into the software storage unit 1005.

Although in the flowchart in FIG. 15, step S33 is present after step S32, the operation in step S33 corresponds to the operation that has been performed when the software for term cancellation has been installed and has been described in the fourth embodiment. Since step S32 will be described later, description thereof is omitted here. When the software for term cancellation is not installed, step S34 is the executed. In step S34, success in software installation is notified to the user 1000.

On the other hand, in step S21, when the software to be installed has been decided to be the paid software for which no term is set (no), the license management unit 1003-C then executes step S22. In step S22, the license information is read out of the license storage unit.

In step S23, the license control unit in the license management unit 1003-C decides whether the number of installable pieces of software that is indicated by the read-out license information is at least one. When the number of installable pieces of software is less than one, the license management 1003-C then executes step S29. On the other hand, when the number of installable pieces of software is at least one, step S24 is then executed. In step S24, the software concerned is read out of the software providing device 1001 and in step S25, the read-out software is written into the software storage unit 1005. In this case, the software is not the paid software on which the license is granted with a term being set and the paid software for which licensing is requested.

In step S26, the license control unit included in the license management unit 1003-C decrements the number of installable pieces of software by one. In step S27, the license information that indicates the number of installable pieces of software obtained by decrement is written into the licensee storage unit. Then, step S28 is executed. In step S28, success in software installation is notified to the user 1000. The above-mentioned steps are repeated every time the paid software is installed. When the number of installable pieces of software is decremented by repeating the steps and becomes less than one, step S29 is executed. In step S29, failure in software installation is notified to the user 1000.

When the software for term cancellation described in the fourth embodiment has been provided to the microprocessor 1002-C, in FIG. 15, step S23 is executed. In step S23, the license information is read out of the license storage unit. It is decided whether the number of installable pieces of software that is indicated by the read-out license information is at least one.

When the number of installable pieces of software is at least one as a result of decision, the logic value “1” is written into the valid term information. In addition, in this case, the number of installable pieces of software is decremented by one and the license information that indicates the number of installable pieces of software obtained by decrement is written into the license management unit 1003-C.

On the other hand, when the number of installable pieces of software is less than one as the result of decision, the valid term information is not changed. In addition, in this case, the number of installable piece of software is not updated. Thereby, when the number of installable pieces of software that is determined by the prepaid license fee is left by at least one, cancellation of the term of the term-limited paid software is possible. In addition, when the number of installable pieces of software is less than one, cancellation of the term of the term-limited paid software is not allowed.

It is also possible to implement the license management unit 10030-C by software. In this case, as illustrated in FIG. 17, each of the paid software SW2 and the term-limited paid software SW3 is controlled by using the software SWC that implements the function of the license management unit 1003-C. The paid software SW2 will be described. When the number of installable pieces of software has become less than one, storage of the paid software SW2 into the software management unit 1005 is inhibited and execution of the paid software SW2 is inhibited. Although description is omitted because description has already been made, in case of the term-limited paid software SW3, when the number of installable pieces of software has become less than one, cancellation of the term is inhibited in the fifth embodiment.

According to the fifth embodiment, it is possible for the user 1000 to execute various kinds of paid software and/or various kinds of term-limited paid software of the number equivalent to the prepaid license fee. Therefore, it is possible for the user 1000 to reduce the load exerted in management of the licenses. In addition, it is possible to cancel the valid term of only the term-limited software that is requested after the term-limited software has been tried. Accordingly, it becomes possible to effectively use the prepaid license fee. On the other hand, it is possible for the seller to prevent the paid software and/or the term-limited paid software from being executed with no licensing. Further, since the license fee is prepaid, it is possible to prevent an omission of license fee collection.

Incidentally, when the software distribution source who provides the paid software and the term-limited paid software is different from the seller who sells the microprocessor 1002-C, it is possible for the software distribution source to promote collection of the license fee while suppressing an increase in load by dividing the license fee that the seller who sells the microprocessor 1002-C has obtained between the seller and the software distribution source.

### Sixth Embodiment

In the first to fifth embodiment, the case where the user 1000 installs the term-limited paid software into the microprocessor 1002 or 1002-C that the user 1000 has purchased via the communication line and so forth has been described. However, the present invention is not limited to the above-mentioned configurations. For example, when the seller provides the microprocessor 1002 or 1002-C to the user 1000, the microprocessor 1001 or 1002-C may be provided by installing in advance (pre-installing) the term-limited software as trial software so as to perform license management.

In this case, the seller sells the microprocessor 1002 or 1002-C by storing in advance such a table as that illustrated in FIG. 5 into the flash memory 1005. In this case, it is made possible to access to the specific storage area 1005-AR of the flash memory 1005 from the outside of the microprocessor 1002 or 1002-C with no intervention of the execution unit 1004. When it has been made so as to be accessible to the specific storage area 1005-AR from the outside of the microprocessor 1002 or 1002-C, it is effective not to allow the user 1000 to falsify the data in the storage area 1005-AR in order to prevent unauthorized acts.

As methods of preventing data falsification, for example, there are a method of allowing an access to the specific storage area only after a serial code has been input from an external terminal, a method that manufacturing testing is performed on the specific storage area 1005-AR only at the wafer stage and the terminal concerned is fixed when packaging (assembling) so as not to be used as the external terminal and so forth.

When the microprocessor configured to cope with a business model that the term-limited software is preinstalled (that is, the term-limited software is not distributed via a network) is used in this way, it becomes possible to eliminate provision of the license management unit and to reduce the data volume of the software to be distributed. Since the term information becomes useless for, for example, the data of the software to be distributed, the data volume is reduced. In addition, for example, although the license management unit checks the valid term information, the license management unit does not perform data addition and data updating. Accordingly, management of the term information is not requested when installing the software and therefore it is possible to reduce the number of circuits used for term information management.

According to the sixth embodiment, since the term-limited software is preinstalled, it becomes possible for the software distribution source 1010 to promote selling of the software. In addition, since it is possible to reduce the number of circuits in the microprocessor, it becomes possible for the user 1000 to promote expense reduction.

### Seventh Embodiment

Similarly to the sixth embodiment, when the seller provides the microprocessor 1002 or 1002-C to the user 1000, the microprocessor 1001 or 1002-C may be provided in a state of installing in advance the term-limited software as the trial software so as to perform license management.

Also in this case, such a table as that illustrated in FIG. 5 is formed in the specific storage area 1005-AR of the flash memory 1005. However, in this case, the seller provides the processor 1002 or 1002-C to the user in a state where only the unique number (ID) of the term-limited software or the address of the term-limited software is registered in the table and the valid information is not registered in the table.

When the user 1000 has used (executed or called) for the first time the term-limited software so preinstalled, the user 1000 registers the valid term information into the table. Thereby, it becomes possible for the user 1000 to use the preinstalled term-limited software for a predetermined period after trial use of the preinstalled software has been started. Consequently, it becomes possible for the user 1000 to try the software use of which has been thought to be useless at the beginning of development of the system using the microprocessor at a halfway stage of development.

Incidentally, the valid term information that is registered into the table when the software has been used for the first time may be a time obtained by adding a fixed time to the power-on time. In addition, when the microprocessor 1002 or 1002-C has been provided in a state of storing the term information of the term-limited software that is preinstalled into the flash memory 1005 and the preinstalled term-limited software has been used, the valid term information to be registered into the table may be defined in accordance with the stored term information and the power-on time.

It goes without saying that also the first to fifth embodiments may be configured so as to register the valid term information into the table when the term-limited software has been executed (used) for the first time. A time that the term-limited software has been executed for the first time is defined as a time that the valid term is started and control based on the term indicated by the term information is performed by doing as mentioned above. Consequently, it becomes possible for the user 1000 to effectively use the valid term.

### APPENDIX

In the present specification, the plurality of inventions are disclosed. Although some of the inventions are described in Claims, the inventions other than those described in Claims are also disclosed. Typical inventions will be listed as follows.

(A) In a license management model used when executing the software on which the license is granted with the term being limited in a semiconductor device that includes the execution unit that executes the software,

the semiconductor device is provided in a state of including the software storage unit coupled to the execution unit and the license management unit that controls execution of the software on which the license is granted with the term being limited by the execution unit on the basis of the term information that indicates the term,

the software is provided from the software providing device to the semiconductor device that has been purchased, the license management unit in the purchased semiconductor device acquires the term information from the provided software and permits the execution unit to execute the software on which the license is granted with the term being limited in the term indicated by the term information.

(B) In the license management model described in (A),

the semiconductor device is provided in a state of storing the license information that indicates the number of licenses into the software storage unit, at the selling price including the license fee according to the number of licenses, and

in the purchased semiconductor device, it is made possible for the license management unit to cancel the term indicated by the term information when the number of licenses that is indicated by the license information stored in the software storage unit is at least the predetermined number of licenses.

(C) In the license management model described in (B),

the license management unit decrements the number of licenses that is indicated by the license information when cancellation of the term indicated by the term information has been performed.

(D) In a license management model used when executing the software on which the license is granted with the term being limited in a semiconductor device that includes the execution unit that executes the software,

the semiconductor device includes the software storage unit coupled to the execution unit and the license management unit that controls execution of the software on which the license is granted with the term being limited by the execution unit on the basis of the term information that indicates the term,

the semiconductor device is provided in a state of storing the software on which the license is granted with the term being limited and the term information into the software storage unit, and

in the purchased semiconductor device, the license management unit acquires the term information from the software storage unit and permits the execution unit to execute the software on which the license is granted with the term being limited in the term indicated by the term information.

Although in the foregoing, the invention that has been made by the inventors and others has been specifically described on the basis of the preferred embodiments of the present invention, it goes without saying that the present invention is not limited to the above-mentioned embodiments and may be altered and modified in a variety of ways within the range not deviating from the gist of the present invention.

Although description has been made by taking the semiconductor device such as the microprocessor and so forth by way of example, the present invention is not limited to the semiconductor device. The microprocessor may be an electronic device such as an information processing device and so forth. In addition, the software storage unit is not limited to the flash memory and may be any nonvolatile storage device. Further the server 1011 of the software distribution source 1010 may not be the server on the communication line and may be a storage device.

Further, the microprocessor 1002 or 1002-C may be a personal computer and so forth and the flash memory 1005 may be a hard disc, a USB memory, an SD card and so forth. Moreover, the server 1011 of the software distribution source 1010 may be a CD-ROM and so forth provided from the software distribution source 1010, and the communication line may be a cable that couples the CD-ROM with the personal computer and so forth.

What is claimed is:

1. A license management method that includes an execution unit that executes software and a software storage unit that is coupled to the execution unit comprising:
a license management unit that controls execution of the software that is stored in the software storage unit and on which a license is granted with a term being limited by the execution unit; and
(a) the controlling step that the license management unit controls execution of the software on which the license is granted with the term being limited by the execution unit on the basis of term information that indicates the term.
(Proposal) A license management method of performing license management by using an execution unit that executes software and a software storage unit that is coupled to the execution unit, comprising the step of:
(a) controlling execution of the software that is stored in the software storage unit and on which a license is granted with a term being limited by the execution unit on the basis of term information that indicate the term by using a license management unit that controls execution of the software that is stored in the software storage unit and on which the license is granted with the term being limited by the execution unit.

2. The license management method according to claim 1, further comprising the step of:
(b) extending the term indicated by the term information,
wherein execution of the software on which the license is granted with the term being limited is made possible in a term that has been extended in the term extending step.

3. The license management method according to claim 1, further comprising the step of:
(c) cancelling the term indicated by the term information.

4. The license management method according to claim 3,
wherein the software storage unit includes license information that indicates a number of licenses, and
wherein when the number of licenses indicated by the license information is at least a predetermined number of licenses, execution of the term cancelling step is permitted.

5. The license management method according to claim 4,
wherein when the term cancelling step has been executed, the number of licenses indicated by the license information is decremented.

6. The license management method according to claim 1, further comprising the step of:
(d) storing the term information that indicates the term into the software storage unit when storing the software on which the license is granted with the term being limited into the software storage unit.

7. The license management method according to claim 1,
wherein the license management unit performs control that is based on the term indicated by the term information since the execution unit has executed the software on which the license has been granted with the term being limited.

8. The license management method according to claim 1,
wherein the term information is stored into the software storage unit, and
wherein the license management unit acquires the term information from the software storage unit.

9. A semiconductor device suited for license management comprising:
an execution unit that executes software;
a software storage unit coupled to the execution unit; and
a license management unit that controls execution of the software that is stored in the software storage unit by the execution unit,
wherein when the execution unit executes the software on which a license is granted with a term being limited, the license management unit limits a term that it is possible for the execution unit to execute the software on which the license is granted with the term being limited on the basis of term information that indicates the term.

10. The semiconductor device suited for license management according to claim 9,
wherein the software storage unit includes an electrically rewritable nonvolatile memory,
wherein the term information is stored into the nonvolatile memory, and
wherein the license management unit acquires the term information from the nonvolatile memory.

11. The semiconductor device suited for license management according to claim 9, further comprising:
a measuring circuit that measures a time,
wherein the license management unit determines a term that it is possible for the execution unit to execute term-limited software in accordance with the time measured by the measuring circuit.
